(19) United States
(12) Patent Application Publication
(10) Pub. No.: US 2005/0062868 A1
(43) Pub. Date: Mar. 24, 2005

(54) Solid-state imaging device and method of driving solid-state imaging device

(76) Inventors: Tomohiro Shiiba, Kanagawa (JP); Takeshi Ide, Kanagawa (JP); Ryoichi Yamamoto, Kanagawa (JP)

Correspondence Address: ROBERT J. DEPKE LEWIS T. STEADMAN;HOLLAND & KNIGHT LLC, 131 SOUTH DEARBORN, 30TH FLOOR, CHICAGO, IL, 60603, US

(21) Appl. No.: 10/903,101

(22) Filed: Jul. 30, 2004

(30) Foreign Application Priority Data
Jul. 31, 2003 (JP) JP2003-283525
Sep. 1, 2003 (JP) JP2003-308846
Mar. 24, 2003 (JP) JP2003-080409

(51) Int. Cl. H04N 5/335

(52) U.S. Cl. 348/316

(57) ABSTRACT

A three-channel-output CCD imaging device includes three horizontal transfer registers. For each transfer stage of the three horizontal transfer registers, m (e.g., two) transfer electrodes are provided. The transfer electrodes are driven independently by clock pulses of six phases, allowing control of potential individually for each of the transfer electrodes.

### BACKGROUND OF THE INVENTION

1. Field of the Invention

The present invention relates to solid-state imaging devices and methods of driving solid-state imaging devices. More specifically, the present invention relates to a multiple-channel-output solid-state imaging device that outputs signal charges in parallel by a plurality of horizontal transfer registers (a horizontal transfer unit), and to a method of driving the solid-state imaging device.

2. Description of the Related Art

With regard to solid-state imaging devices used as imaging devices of camera modules, such as charge-coupled-device (CCD) imaging devices (hereinafter referred to as CCD imaging devices), a high demand for increasing frame rate exists in order to implement camera functions such as progressive operation, variable speed, and super motion. As a technique for increasing frame rate of CCD imaging devices, a technique of multiple-channel output is known, in which a plurality of horizontal transfer registers is provided and a plurality of lines of signals is output in parallel by the plurality of horizontal transfer registers, thereby decreasing the driving frequency of the horizontal transfer registers.

That is, according to the technique of multiple-channel output, the number of horizontal transfer registers is increased to decrease the driving frequency when the frame rate is high. Among techniques of multiple-channel output, a two-channel-output structure having two horizontal transfer registers has been known. In a CCD imaging device having two horizontal transfer registers, a pair of two horizontal transfer electrodes composed of, for example, polycrystalline silicon, is used. Two-phase clock pulses φ1 and φ2 having mutually opposite phases are applied to the horizontal transfer electrodes to carry out a horizontal transfer operation, and an inter-register transfer channel and an inter-register transfer gate are used for transferring between horizontal transfer registers. Such a CCD imaging device is disclosed, for example, in Japanese Unexamined Patent Application Publication No. 10-200819.

FIG. 1 schematically shows the construction of two horizontal transfer registers. In FIG. 1, hatched regions represent channel stop regions, and regions surrounded by broken lines represent transfer electrodes to which clock pulses of a common phase are supplied. In the construction of the two horizontal transfer registers 101 and 102, a horizontal transfer register at the sending side (the transfer electrode to which a clock pulse φH1 is applied in FIG. 1) is pulled to low level (hereinafter referred to as “L” level) to render the potential under the transfer electrode shallow, and the horizontal transfer electrode at the receiving side (the transfer electrode to which the clock pulse φH2 is applied in FIG. 1) is pulled to high level (hereinafter referred to as “H” level) to render the potential under the transfer electrode deep, whereby a signal charge is transferred between the horizontal transfer registers 101 and 102.

The multiple-channel-output CCD imaging device according to the related art, when the number of horizontal transfer registers is two, allows multiple-channel output without causing problems such as mixing of signal charges. However, when the number of horizontal transfer registers is increased to three or more in order to achieve an even higher frame rate, problematically, signal charges are mixed. This will be described more specifically with reference to FIG. 1. For simplicity of description, the description will be made in the context of an example where three horizontal transfer registers are provided.

In the structure including three horizontal transfer registers, in order to arrange signal charges to the three horizontal transfer registers 111, 112, and 113 in order, inter-register transfer channels 114 and 115, one being provided for each set of three pairs of two transfer electrodes, are needed. When signal charges are transferred between registers in the above structure similarly to the case where the number of horizontal transfer registers is two, potential is reversed between the sending channel and the receiving channel. Thus, even though the inter-register transfer channels 114 and 115 exist, signal charges are not transferred between registers, and signal charges are mixed since a signal charge immediately adjacent to the right is horizontally transferred.

The former problem that signal charges are not transferred between registers can be avoided by providing an even number of horizontal transfer registers. It is to be understood, however, that even in that case, when a horizontal transfer operation is executed even once after signal charges are once transferred between registers, signal charges are mixed.

In a camera module, usually, operation is switched between normal frame rate operation such as 1/60 second interlace scanning or 1/30 second progressive scanning, and high frame rate operation such as 1/60 second progressive scanning or 1/90 second progressive scanning. Interlace scanning horizontally scans every other line, while progressive scanning horizontally scans all the lines sequentially.

In a CCD imaging device, the driving frequency of horizontal transfer registers changes according to switching between normal frame rate operation and high frame rate operation. Thus, the number of horizontal transfer registers, i.e., the number of channels, is determined so that driving frequencies of high frame rate operations can be achieved. In a normal frame rate operation, the driving frequency is decreased by “high frame rate” divided by “normal frame rate”. When the driving frequency of the horizontal transfer registers is decreased, the load of the system is reduced, for example, power consumption is reduced.

On the other hand, since signals of a plurality of channels are multiplexed to generate a video signal, a low-pass filter for removing components of the driving frequency must be provided in a signal processing system to decrease the degree of amplitude modulation in the vicinity of limiting resolution. For example, relative to a high frame rate operation of 1/90 second progressive scanning with three horizontal transfer registers, the driving frequency is decreased to 1/3 in a normal frame rate operation of 1/60 second interlace scanning or 1/30 second progressive scanning, so that the degree of modulation in the vicinity of limiting resolution is decreased. When the degree of modulation in the vicinity of limiting resolution is decreased, the bandwidth of video signals is reduced, causing decrease in resolution.

### SUMMARY OF THE INVENTION

The present invention, in one aspect thereof, provides a solid-state imaging device including a pixel area where pixels including photoelectric conversion elements are disposed; and a charge transferring unit that transfers n channels of signal charges in parallel, the signal charges being obtained by photoelectric conversion by the pixels in the pixel area, where n is an integer not smaller than two. The charge transferring unit includes n transfer registers having transfer stages that sequentially transfer signal charges, each of the transfer stages having m transfer electrodes, where m is an integer not smaller than two, the respective transfer electrodes being driven independently by clock pulses of m×n phases; and inter-register transfer gates provided between the n transfer registers at an interval of at least one of the transfer electrodes.

The present invention, in another aspect thereof, provides a solid-state imaging device including a pixel area that carries out photoelectric conversion; and a charge transferring unit that transfers signal charges obtained by the pixel area. The charge transferring unit includes n transfer registers having transfer stages that sequentially transfer the signal charges, where n is an integer not smaller than two, each of the transfer stages having m transfer electrodes, where m is an integer not smaller than two, the transfer electrodes being driven by clock pulses of m×n phases; and a set of inter-register transfer channels that transfers signal charges between the n transfer registers, the inter-register transfer gates being provided between the n transfer registers at an interval of at least one of the transfer electrodes; a set of gate electrodes provided over the set of inter-register transfer channels; and driving means for applying biases to a number of gate electrodes among the set of gate electrodes in accordance with a number of transfer registers that is used among the n transfer registers.

The present invention, in another aspect thereof, provides a method of driving a solid-state imaging device. The solid-stage imaging device including a pixel area where pixels including photoelectric conversion elements are disposed; and a charge transferring unit that transfers n channels of signal charges in parallel, the signal charges being obtained by photoelectric conversion by the pixels in the pixel area, where n is an integer not smaller than two. The charge transferring unit includes n transfer registers having transfer stages that sequentially transfer signal charges, each of the transfer stages having m transfer electrodes, where m is an integer not smaller than two; and inter-register transfer gates provided between the n transfer registers at an interval of at least one of the transfer electrodes. The respective transfer electrodes of the n transfer registers are driven independently by clock pulses of m×n phases.

The present invention, in another aspect thereof, provides a method of driving a solid-state imaging device. The solid-state imaging device includes a pixel area that carries out photoelectric conversion; and a charge transferring unit that transfers signal charges obtained by the pixel area. The charge transferring unit includes n transfer registers having transfer stages that sequentially transfer the signal charges, where n is an integer not smaller than two, each of the transfer stages having m transfer electrodes, where m is an integer not smaller than two, the transfer electrodes being driven by clock pulses of m×n phases; a set of inter-register transfer channels that transfers signal charges between the n transfer registers, the inter-register transfer gates being provided between the n transfer registers at an interval of at least one of the transfer electrodes; and a set of gate electrodes provided over the set of inter-register transfer channels. Biases are applied to a number of gate electrodes among the set of gate electrodes in accordance with a number of transfer registers that is used among the n transfer registers.

### BRIEF DESCRIPTION OF THE DRAWINGS

FIG. 1 is a schematic diagram showing the construction of a two-channel-output horizontal transfer unit according to the related art;

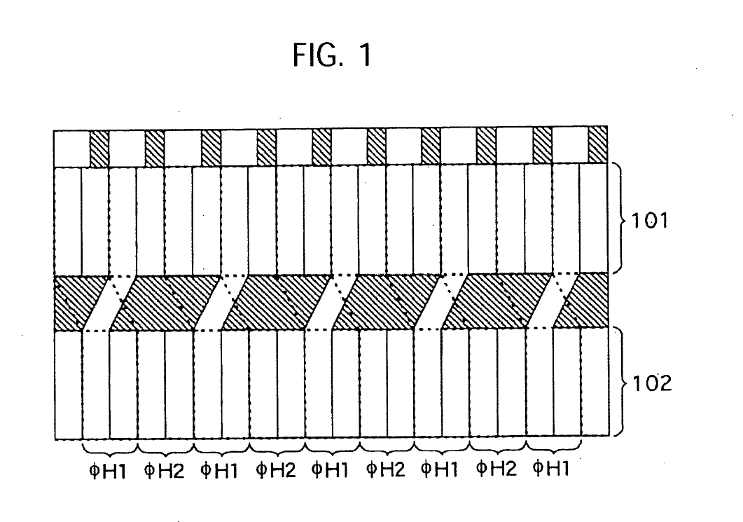

FIG. 2 is an operation diagram for explaining a problem of the related art;

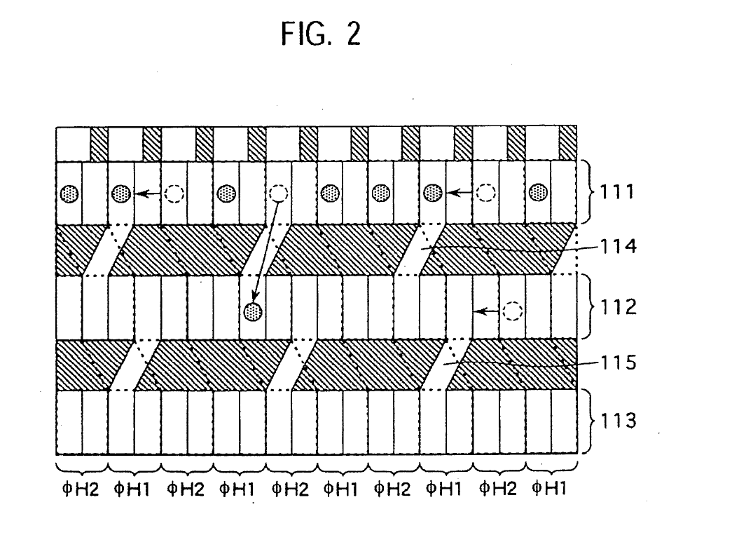

FIG. 3 is a schematic diagram showing the overall construction of a CCD imaging device according to a first embodiment of the present invention;

FIG. 4 is a schematic diagram showing a planar pattern of a specific structure of a horizontal transfer unit;

FIG. 5 is a timing chart for explaining an operation of the CCD imaging device according to the first embodiment;

FIG. 6 is an operation diagram of the CCD imaging device according to the first embodiment;

FIG. 7 is an operation diagram of the CCD imaging device according to the first embodiment;

FIG. 8 is an operation diagram of the CCD imaging device according to the first embodiment;

FIG. 9 is an operation diagram of the CCD imaging device according to the first embodiment;

FIG. 10 is an operation diagram of the CCD imaging device according to the first embodiment;

FIG. 11 is an operation diagram of the CCD imaging device according to the first embodiment;

FIG. 12 is an operation diagram of the CCD imaging device according to the first embodiment;

FIG. 13 is a timing chart for explaining an inter-register transfer operation in a first example;

FIG. 14 is an operation diagram for explaining the inter-register transfer operation in the first example;

FIG. 15 is a timing chart for explaining an inter-register transfer operation in a second example;

FIG. 16 is an operation diagram for explaining the inter-register transfer operation in the second example;

FIG. 17 is a timing chart for explaining an inter-register transfer operation in a third example;

FIG. 18 is an operation diagram for explaining the inter-register transfer operation in the third example;

FIG. 19 is a timing chart for explaining an inter-register transfer operation in a fourth example;

FIG. 20 is an operation diagram for explaining the inter-register transfer operation in the fourth example;

FIG. 21 is a timing chart for explaining a horizontal transfer operation for assigning signal charges;

FIG. 22 is an operation diagram for explaining the horizontal transfer operation for assigning signal charges;

FIG. 23 is a timing chart for explaining a horizontal transfer operation after assigning signal charges;

FIG. 24 is an operation diagram for explaining the horizontal transfer operation after assigning signal charges;

FIG. 25 is a schematic diagram showing the overall construction of a CCD imaging device according to a second embodiment of the present invention;

FIG. 26 is a schematic diagram showing a planar pattern of a specific structure of a horizontal transfer unit in the CCD imaging device according to the second embodiment;

FIG. 27 is a sectional view showing an example structure taken along a line XXVII-XXVII in FIG. 26;

FIG. 28 is a timing chart for explaining an operation in a three-channel-output operation mode;

FIG. 29 is an operation diagram for explaining the three-channel-output operation mode;

FIG. 30 is a timing chart for explaining an operation in a two-channel-output operation mode; and

FIG. 31 is an operation diagram for explaining the two-channel-output operation mode.

### DESCRIPTION OF THE PREFERRED EMBODIMENTS

Now, embodiments of the present invention will be described in detail with reference to the drawings.

First Embodiment

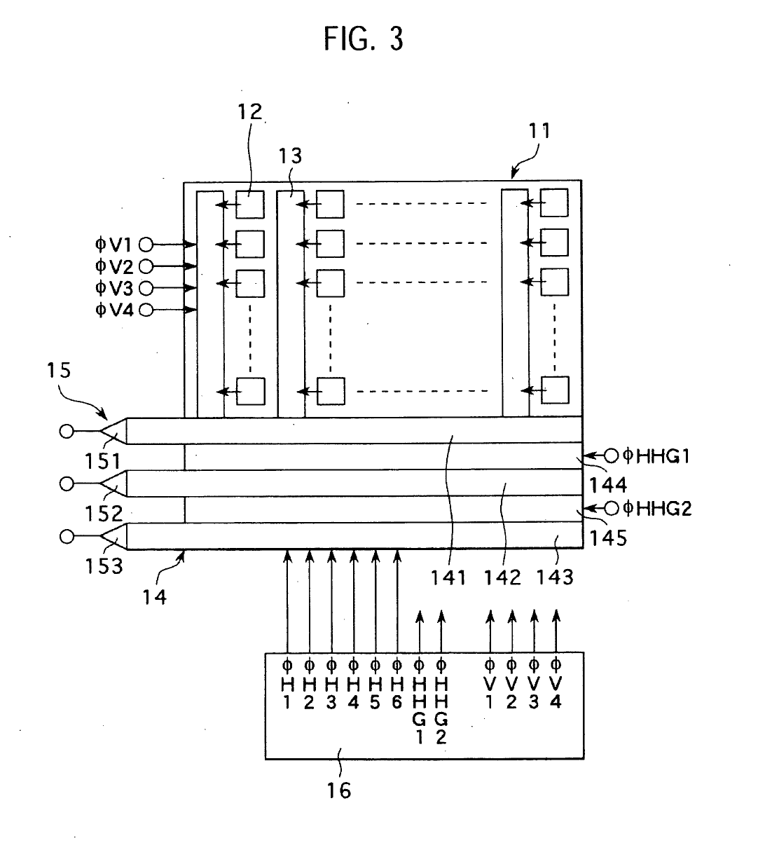

FIG. 3 is a schematic diagram showing the overall construction of a solid-state imaging device, such as a CCD imaging device, according to a first embodiment of the present invention.

Referring to FIG. 3, an imaging unit 11 includes a pixel area including a matrix of sensor units (pixels) 12, and a vertical transfer unit including a plurality of vertical transfer registers 13 respectively associated with the vertical columns of the sensor units 12. Each of the sensor units 12 includes a photoelectric conversion element such as a photodiode, and it converts an incident light into signal charges of an amount corresponding to the amount of the incident light and accumulates the signal charges. Each of the vertical transfer registers 13 is implemented by a CCD including a series of a large number of transfer stages (register stages) that serve as units for sequentially transferring signal charges. For example, the vertical transfer registers 13 are driven by four-phase clock pulses φV1 to φV4 to vertically transfer signal charges read from the sensor units 12, shifting the signal charges line by line (row by row) to a horizontal transfer unit 14.

The horizontal transfer unit 14 includes, for example, three horizontal transfer registers 141, 142, and 143 and inter-register transfer gates 144 and 145. The horizontal transfer registers 141, 142, and 143 horizontally transfer in parallel signal charges having been shifted line by line from the respective vertical transfer registers 13. The inter-register transfer gates 144 are provided between the horizontal transfer registers 141 and 142, and transfer signal charges from the horizontal transfer register 141 closer to the imaging unit 11 to the horizontal transfer register 142 remoter from the imaging unit 11. The inter-register transfer gates 145 are provided between the horizontal transfer register 142 and the horizontal transfer register 143, and transfer signal charges from the horizontal transfer register 142 closer to the imaging unit 11 to the horizontal transfer register 143 remoter from the imaging unit 11.

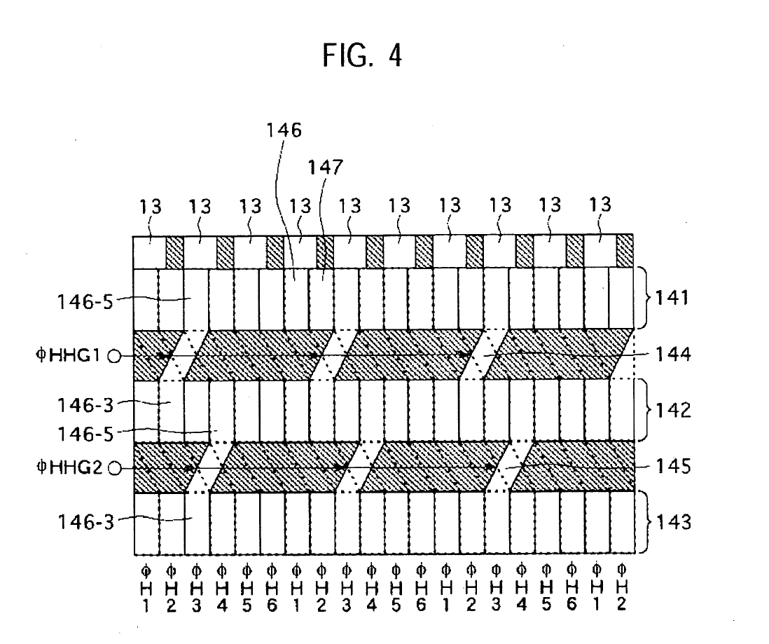

FIG. 4 schematically shows a specific structure of the horizontal transfer unit 14. In FIG. 4, hatched regions represent channel stop regions, and regions surrounded by broken lines represent transfer electrodes to which clock pulses of a common phase are applied. Each of the horizontal transfer registers 141, 142, and 143 is implemented by a CCD including a series of a large number of transfer stages (register stages) that serve as units for sequentially transferring signal charges. Each of the transfer stages includes m transfer electrodes (m is an integer not smaller than two), e.g., two transfer electrodes 146 and 147. That is, a transfer stage is formed by two transfer electrodes 146 and 147 and channel regions under the transfer electrodes 146 and 147. Six transfer electrodes associated with three adjacent transfer stages are considered as a unit, and clock pulses φH1 to φH6 of six (=2×3) phases are independently applied to the respective six transfer electrodes.

The inter-register transfer gates 144 are provided between the horizontal transfer register 141 and the horizontal transfer register 142, at an interval of one unit of two transfer electrodes 146 and 147 (i.e., one pixel), in this embodiment, at an interval of two transfer stages, i.e., one for each set of three transfer stages (i.e., six transfer electrodes). A gate pulse φHHG1 is applied to gate electrodes, whereby signal charges in the horizontal transfer register 141 are selectively transferred to the horizontal transfer register 142 through channels under the gate electrodes. More specifically, entrances of the channels of the inter-register transfer gates 144 are formed so as to communicate with the channels under transfer electrodes 146-5 of the horizontal transfer register 141 to which the fifth-phase clock pulse φH5 is applied, and exits of the channels are formed so as to communicate with the channels under transfer electrodes 146-3 of the horizontal transfer register 142 to which the third-phase clock pulse φH3 is applied.

The inter-register transfer gates 145 are provided between the horizontal transfer register 142 and the horizontal transfer register 143, one being provided for each set of three transfer stages of two transfer electrodes 146 and 147 (i.e., for each set of six transfer electrodes). A gate pulse φHHG2 is applied to gate electrodes, whereby signal charges in the horizontal transfer register 142 are selectively transferred to the horizontal transfer register 143 through channels under the gate electrodes. More specifically, entrances of the channels of the inter-register transfer gates 145 are formed so as to communicate with the channels under the transfer electrodes 146-5 of the horizontal transfer register 142 to which the fifth-phase clock pulse φH5 is applied, and exits of the channels are formed so as to communicate with the channels under the transfer electrodes 146-3 of the horizontal transfer register 143 to which the third-phase clock pulse φH3 is applied.

That is, the horizontal transfer unit 14 has three output channels with the three horizontal transfer registers 141, 142, and 143. The horizontal transfer unit 14 assigns signal charges transferred to the horizontal transfer register 141 line by line from the respective vertical transfer registers 13 to the horizontal transfer registers 142 and 143 by operations of the inter-register transfer gates 144 and 145, and then horizontally transfers the signal charges in parallel by the three horizontal transfer registers 141, 142, and 143.

Referring back to FIG. 3, the signal charges associated with the three channels of the horizontal transfer unit 14 are converted into electric signals by a charge detecting unit 15. The charge detecting unit 15 includes floating-diffusion charge-voltage converters 151, 152, and 153 provided at transfer-destination-side ends of the horizontal transfer registers 141, 142, and 143. The charge detecting unit 15 converts the signal charges associated with the three channels, transferred by the horizontal transfer registers 141, 142, and 143, into voltage signals.

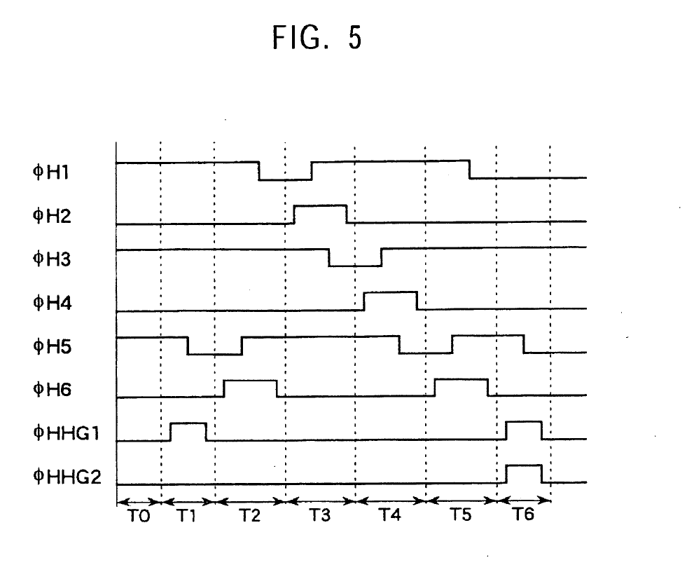

A timing generator 16, together with a driver and other associated parts that are not shown, forms controlling means that drives and controls the three-output-channel CCD imaging device constructed as described above. The timing generator 16 generates various timing pulses including the four-phase clock pulses φV1 to φV4 for driving the vertical transfer registers 13, the six-phase clock pulses φH1 to φH6 for driving the horizontal transfer registers 141, 142, and 143, and gate pulses φHHG1 and φHHG2. FIG. 5 shows an example of driving timing of the six-phase clock pulses φH1 to φH6 and the gate pulses φHHG1 and φHHG2.

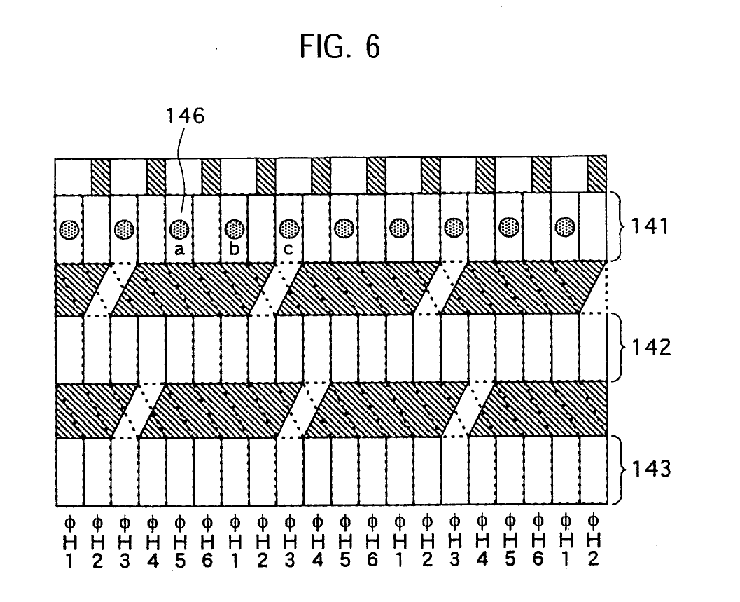

Next, an operation of the three-channel-output CCD imaging device according to the first embodiment will be described based on a timing chart shown in FIG. 3 and with reference to operation diagrams shown in FIGS. 6 to 12. In the case of three-channel output, with regard to signal charges associated with one line, signal charges of three adjacent pixels are considered as a unit, and the signal charges of the three pixels are assigned to the three horizontal transfer registers 141, 142, and 143 and are horizontally transferred in parallel by the horizontal transfer registers 141, 142, and 143.

During a period T0, the odd-numbered-phase clock pulses φH1, φH3, and φH5 are at “H” level, and the even-numbered-phase clock pulses φH2, φH4, and φH6 are at “L” level. Under this state, first, signal charges associated with one line are transferred from the respective vertical transfer registers 13 to the horizontal transfer register 141. At this time, as shown in FIG. 6, the signal charges associated with one line, transferred from the respective vertical transfer registers 13, are accumulated on a pixel-by-pixel basis under the transfer electrodes 146 of the horizontal transfer register 141. In order to facilitate understanding of the following description of operation, three signal charges that are third to fifth from the left in FIG. 6 will be denoted as a signal charge a, a signal charge b, and a signal charge c from the left, respectively, and description will be made with respect to these three signal charges a to c.

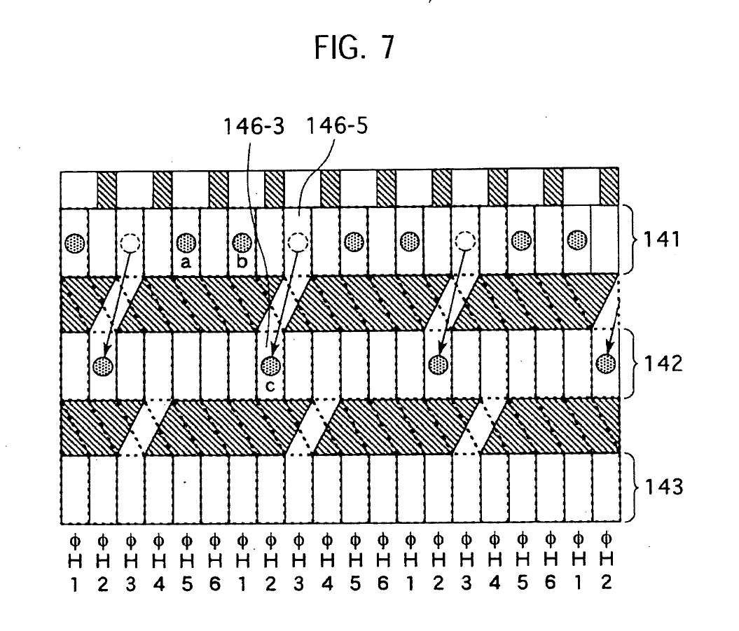

During a period T1, a first inter-register transfer operation is carried out. More specifically, first, the gate pulse φHHG1 is pulled to “H” level, whereby a transfer channel is formed under an inter-register transfer gate 144 between a channel region under a transfer electrode 146-5 of the horizontal transfer register 141 to which the fifth-phase clock pulse φH5 is applied and a channel region under a transfer electrode 146-3 of the horizontal transfer register 142 to which the third-phase clock pulse φH3 is applied. Then, the clock pulse φH5 is pulled to “L” level, whereby the signal charge c is transferred from the horizontal transfer register 141 to the horizontal transfer register 142 through the inter-register transfer gate 144, as shown in FIG. 7.

By pulling the clock pulse φH5 to “L” level after pulling the gate pulse φHHG1 to “H” level, the potential of the channel region of the horizontal transfer register 141 where the signal charge c is accumulated becomes shallow, so that transfer of the signal charge c from the horizontal transfer register 141 to the horizontal transfer register 142 is facilitated. Finally, the gate pulse φHHG1 is pulled back to “L” level, whereby the first inter-register transfer operation is completed. The inter-register transfer operation will be described later in more detail.

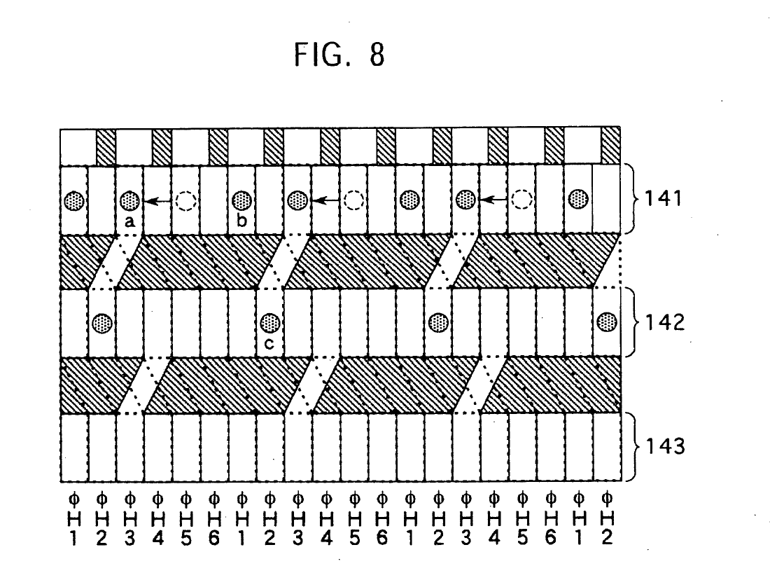

Next, during a period T2, first, the sixth-phase clock pulse φH6 is pulled to “H” level, then the fifth-phase clock pulse φH5 is pulled to “H” level, then the first-phase clock signal φH1 is pulled to “L” level, and finally the sixth-phase clock pulse φH6 is pulled to “L” level. Thus, as shown in FIG. 8, in the horizontal transfer register 141, the signal charge a is horizontally transferred to a region under a transfer electrode 146 that is second next to the left. The horizontal transfer operation will also be described later in more detail.

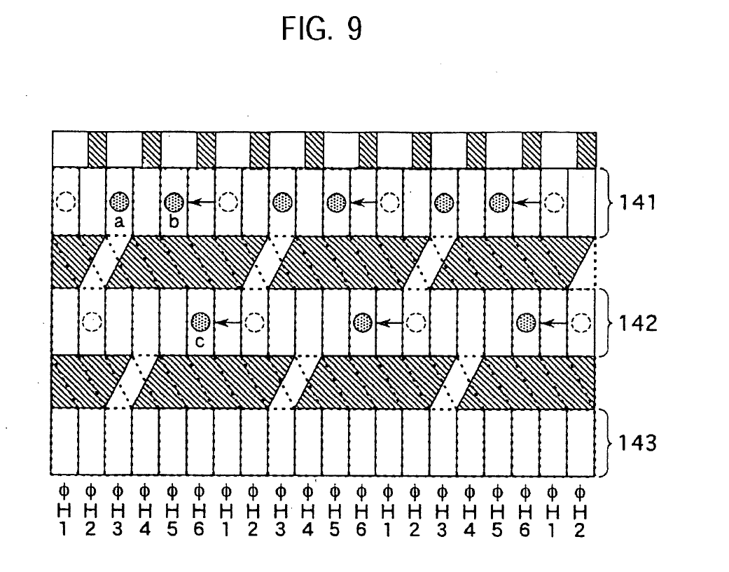

Next, during a period T3, first, the second-phase clock pulse φH2 is pulled to “H” level, then the first-phase clock pulse φH1 is pulled to “H” level, then the third-phase clock pulse is pulled to “L” level, and finally the second-phase clock pulse φH2 is pulled back to “L” level. Thus, as shown in FIG. 9, the signal charge b is transferred to a region under a transfer electrode 146 that is second next to the left in the horizontal transfer register 141, and the signal charge c is transferred to a region under a transfer electrode 146 that is second next to the left in the horizontal transfer register 142.

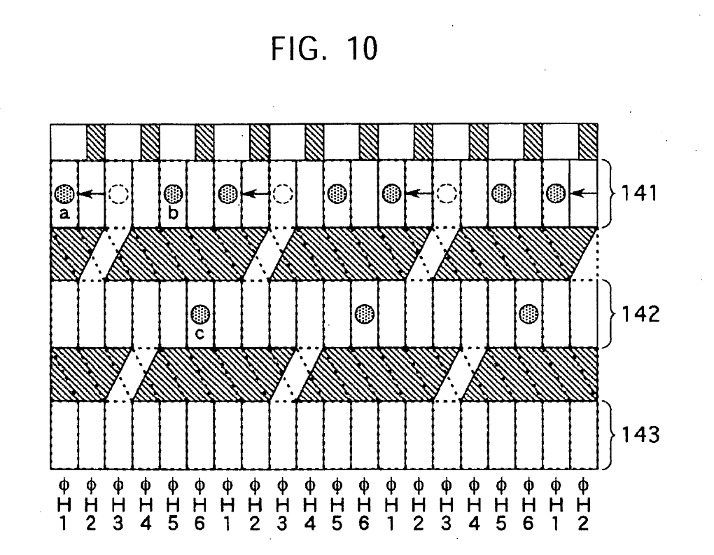

Next, during a period T4, first, the fourth-phase clock pulse φH4 is pulled to “H” level, then the third-phase clock pulse φH3 is pulled to “H” level, then the fifth-phase clock pulse φH5 is pulled to “L” level, and finally the fourth-phase clock pulse φH4 is pulled back to “L” level. Thus, as shown in FIG. 10, the signal charge a is horizontally transferred to a region under a transfer electrode 146 that is further second next to the left in the horizontal transfer register 141.

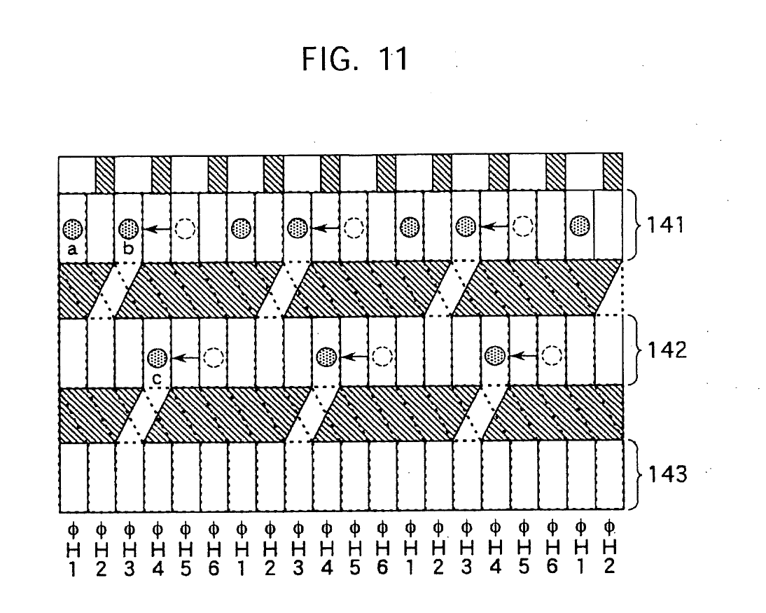

Next, during a period T5, first, the sixth-phase clock pulse φH6 is pulled to “H” level, then the fifth-phase clock pulse φH5 is pulled to “H” level, then the first-phase clock pulse φH1 is pulled to “L” level, and finally the sixth-phase clock pulse φH6 is pulled back to “L” level. Thus, as shown in FIG. 11, the signal charge b is horizontally transferred to a region under a transfer electrode 146 that is further second next to the left in the horizontal transfer register 141, and the signal charge c is horizontally transferred to a region under a transfer electrode 146 that is further second next to the left in the horizontal transfer register 142.

Next, during a period T6, a second inter-register transfer operation is carried out. More specifically, first, the gate pulses φHHG1 and φHHG2 are both pulled to “H” level, whereby a transfer channel is formed under the inter-register transfer gate 144 between the channel region under the transfer electrode 146-5 of the horizontal transfer register 141 to which the fifth-phase clock pulse φH5 is applied and the channel region under the transfer electrode 146-3 of the horizontal transfer register 142 to which the third-phase clock pulse φH3 is applied. Also, a transfer channel is formed under the inter-register transfer gate 145 between the channel region under the transfer electrode 146-5 of the horizontal transfer register 142 to which the fifth-phase clock pulse φH5 is applied and the channel region under the transfer electrode 146-3 of the horizontal transfer register 143 to which the third-phase clock pulse φH3 is applied.

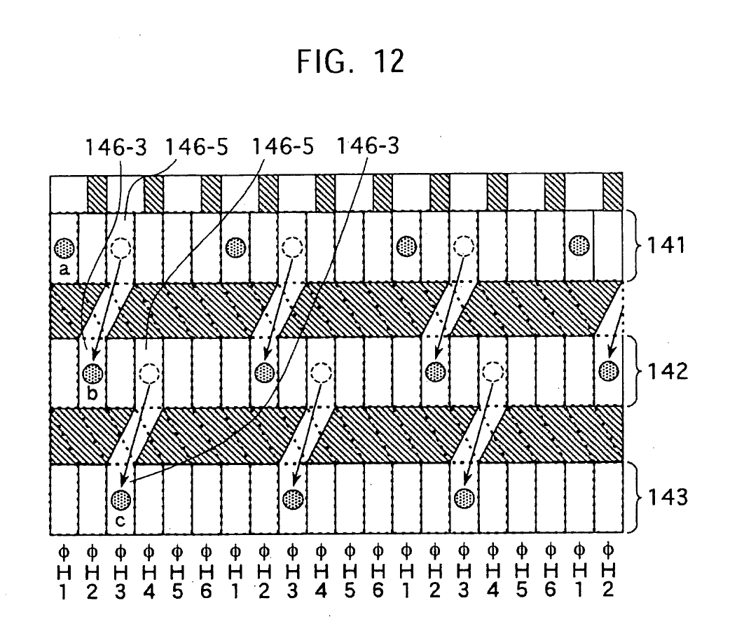

Then, the clock pulse φH5 is pulled to “L” level, whereby the signal charge b is transferred from the horizontal transfer register 141 to the horizontal transfer register 142 through the inter-register transfer gate 144, and the signal charge c is transferred from the horizontal transfer register 142 to the horizontal transfer register 143 through the inter-register transfer gate 145, as shown in FIG. 12. By pulling the clock pulse φH5 to “L” level after pulling the gate pulses φHHG1 and φHHG2 to “H” level, the signal charge b is transferred from the horizontal transfer register 141 to the horizontal transfer register 142 through the inter-register transfer gate 144, and the signal charge c is transferred from the horizontal transfer register 142 to the horizontal transfer register 143 through the inter-register transfer gate 145. Finally, the gate pulses φHHG1 and φHHG2 are both pulled back to “L” level, whereby assigning of the signal charges b and c to the horizontal transfer registers 142 and 143 is completed.

As described above, signal charges that are sequentially supplied line by line from the imaging unit 11 are assigned to the three horizontal transfer registers 141, 142, and 143 by inter-register transfer operations of the inter-register transfer gates 144 and 145, and are then horizontally transferred in parallel by the horizontal transfer registers 141, 142, and 143.

During the horizontal transfer operations, in order to inhibit mixture of signal charges through the inter-register transfer gates 144 between the horizontal transfer registers 141 and 142 and the inter-register transfer gates 145 between the horizontal transfer registers 142 and 143, the “L” level of the gate pulses φHHG1 and φHHG2 is chosen to be lower than the “L” level of the clock pulses φH1 to φH6 for the horizontal transfer registers 141, 142, and 143, so that the potentials of the inter-register transfer gates 144 and 145 are even shallower than the shallow potentials of the horizontal transfer registers 141, 142, and 143.

As described above, in a multiple-channel-output CCD imaging device having n (three in this embodiment) horizontal transfer registers, m (two in this embodiment) transfer electrodes 146 and 147 are provided for each transfer stage of the horizontal transfer registers, and the transfer electrodes 146 and 147 are driven independently by clock pulses of m×n phases, in this embodiment, the clock pulses φH1 to φH6 of sixth (=2×3) phases, respectively. Thus, the potentials of channels can be controlled individually for each of the transfer electrodes. Accordingly, potential is not reversed between a sending channel and a receiving channel does not occur, and horizontal transfer does not occur while signal charges are being assigned.

Therefore, inter-register transfer operations are executed reliably even in the case of a multiple-channel-output CCD imaging device having three or more horizontal transfer registers. Thus, the number of horizontal transfer registers can be increased as desired. Accordingly, even when the number of pixels is increased, a high frame rate can be achieved by increasing the number of horizontal transfer registers, and the increased frame rate allows decrease in the driving frequency of horizontal transfer operations. This serves to reduce power consumption of the CCD imaging device.

Furthermore, when signal charges are assigned to the n horizontal transfer registers, n adjacent signal charges, in this embodiment, three signal charges a, b, and c, are considered as a unit. The leading signal charge a is left in the uppermost horizontal transfer register, and the two signal charges b and c following the signal charge a are horizontally transferred in order to the entrances of the channels of the inter-register transfer gates 144 and 145, so that the signal charges a, b, and c are finally arranged under transfer electrodes of the three horizontal transfer registers 141, 142, and 143 to which clock pulses of a common phase are applied. This serves to reduce time required for assigning signal charges.

In particular, the entrances of the channels of the inter-register transfer gates 144 and 145 are formed under transfer electrodes to which clock pulses of a phase that is common between the horizontal transfer registers 141 and 142 that send signal charges are applied, in this embodiment, under the transfer electrodes 146-5 to which the fifth-phase clock pulses φH5 are applied. Furthermore, the exits of the channels are formed under transfer electrodes to which clock pulses of a phase that is common between the horizontal transfer registers 142 and 143 that receive signal charges and that is different from the phase of the clock pulses of the sending side are applied, in this embodiment, under the transfer electrodes 146-3 to which the third-phase clock pulses φH3 are applied. Thus, in the second inter-register transfer operation, the signal charges b and c are transferred simultaneously. Accordingly, signal charges can be assigned in a shorter time compared with a case where the signal charges are separately transferred between registers.

Since m transfer electrodes are provided for each transfer stage of horizontal transfer registers, and the transfer electrodes are driven independently by clock pulses of m×n phases, the potentials of channels can be controlled individually for each of the transfer electrodes. With this advantage, instead of unidirectional horizontal transfer, signal charges may be transferred in mutually opposite directions with respect to a border set in the middle between horizontal transfer registers so that time required for horizontal transfer operations will be reduced.

Inter-Register Transfer Operation

Next, inter-register transfer operations from the horizontal transfer register 141 to the horizontal transfer register 142 and from the horizontal transfer register 142 to the horizontal transfer register 143 during the periods T1 to T6 described above will be described more specifically with examples.

As described earlier, in order to inhibit mixture of signal charges among the horizontal transfer registers 141, 142, and 143 during horizontal transfer operations, the “L” level of the gate pulses φHHG1 and φHHG2 is chosen to be lower than the “L” level of the clock pulses φH1 to φH6 for driving the horizontal transfer registers 141, 142, and 143. In the following examples, the “L” level of the gate pulses φHHG1 and φHHG2 will be denoted as “L′” level. In the examples described below, inter-register transfer operations are controlled by controlling timing and levels of the clock pulses φH1 to φH6 and the gate pulses φHHG1 and φHHG2 by the timing generator 16.

First Example

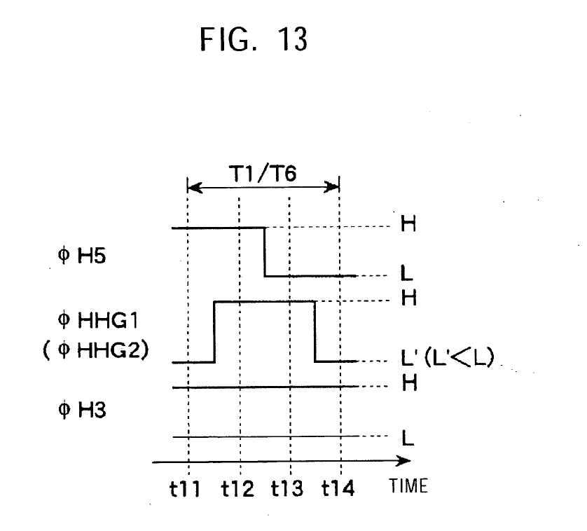

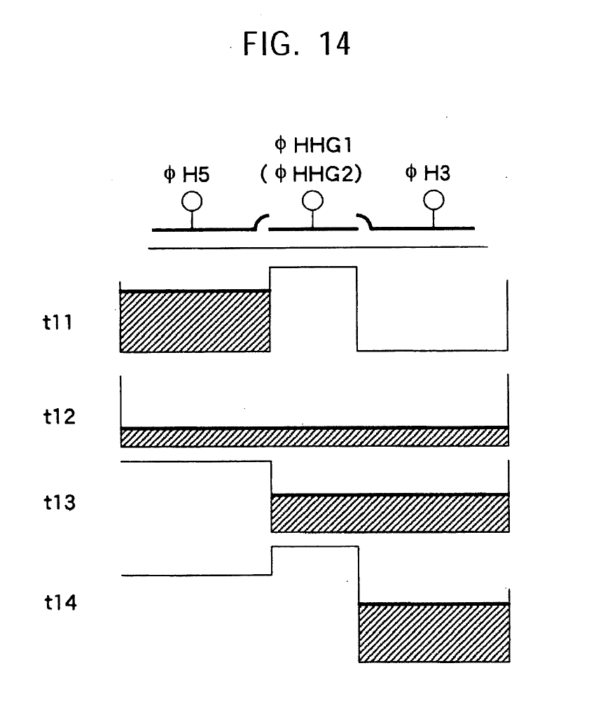

FIG. 13 is a timing chart for explaining an inter-register transfer operation in a first example. FIG. 13 shows timing relationship of the third-phase and fifth-phase clock pulses φH3 and φH5 and the gate pulse φHHG (φHHG1 or φHHG2) during the periods T1 and T6. FIG. 14 is an operation diagram for explaining the inter-register transfer operation in the first example.

During the periods T1 and T6 in FIG. 5, at time t11, the clock pulses φH3 and φH5 are both at “H” level and the gate pulse φHHG is at “L′” level, so that signal charges are accumulated under the transfer electrodes 146-5 of the horizontal transfer registers 141 and 142 to which the clock pulse φH5 is applied. At time t12, the clock pulses φH3 and φH5 and the gate pulse φHHG are all at “H” level, so that signal charges flow into regions under the transfer electrodes 146-3 of the inter-register transfer gates 144 and 145 to which the clock pulse φH3 is applied.

At time t13, the clock pulse φH5 is at “L” level, and the potentials under the transfer electrodes 146 to which the clock pulse φH5 is applied become shallow. Thus, signal charges under the transfer electrodes 146-5 of the horizontal transfer registers 141 and 142 to which the clock pulse φH5 is applied are pushed out to the inter-register transfer gates 144 and 145 and the regions under the transfer electrodes 146-3 of the horizontal transfer registers 142 and 143 to which the clock pulse φH3 is applied.

At time t14, the gate pulse φHHG is back at “L′” level, and the potentials of the inter-register transfer gates 144 and 145 become shallow, so that signal charges in the inter-register transfer gates 144 and 145 are pushed out to the regions under the transfer electrodes 146-3 of the horizontal transfer registers 142 and 143 to which the clock pulse φH3 is applied.

By the sequence of operations described above, the first inter-register transfer operation and the second inter-register transfer operation are carried out. By the inter-register transfer operations, signal charges associated with one line, transferred from the respective vertical transfer registers to the horizontal transfer register 141, are assigned to the horizontal transfer registers 142 and 143.

As described above, in the inter-register transfer operation from the horizontal transfer register 141 to the horizontal transfer register 142 or the inter-register transfer operation from the horizontal transfer register 142 to the horizontal transfer register 143, when signal charges associated with one pixel are accumulated under a channel of a sending transfer electrode of the horizontal transfer register 141 or 142, first, the potential of the inter-register transfer gate 144 or 145 is rendered deeper to increase signal charges accumulated, then the potential under a receiving transfer electrode is rendered deeper to increase accumulated signal charges, and then the potential under the sending transfer electrode and the potential of the inter-register transfer gate 144 or 145 are rendered shallower, whereby signal charges are sequentially pushed from the trailing side. Thus, signal charges are reliably transferred between registers without causing residual signal charges.

In the inter-register transfer operations in this example, as will be understood from the timing chart shown in FIG. 13, during a period between time t13 and time t14, the gate pulse φHHG is instantaneously shifted from “H” level to “L′” level so that signal charges will be transferred at once from the inter-register transfer gate 144 to the horizontal transfer register 142 or from the inter-register transfer gate 145 to the horizontal transfer register 143.

In this case, in order to inhibit mixture of signal charges among the horizontal transfer registers 141, 142, and 143 during horizontal transfer operations, considering that the potentials of the inter-register transfer gates 144 and 145 must be shallower than the shallow potentials of the horizontal transfer registers 141, 142, and 143, when the potentials of the inter-register transfer gates 144 and 145 are shallow, it could occur that signal charges remain in the inter-register transfer gates 144 and 145 and reversely flow into the horizontal transfer registers 141 and 142.

In view of the above, second to fourth examples of inter-register operations will be described below. In the second to fourth examples of inter-register operations, except in a period between time t13 to time t14, the operation is the same as the operation in the first example. Thus, it is to be understood that the same advantages achieved in the first example are achieved in the second to fourth examples of inter-register operations.

Second Example

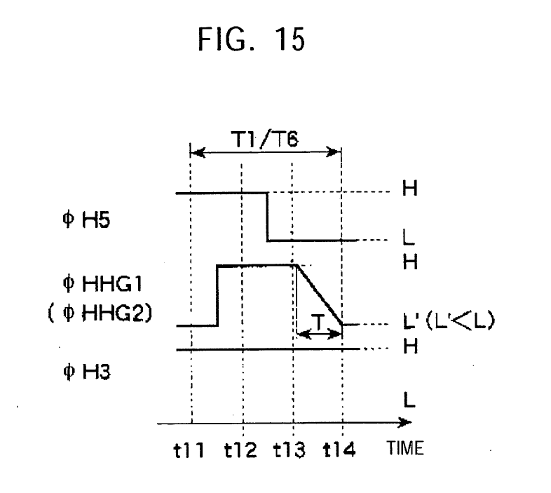

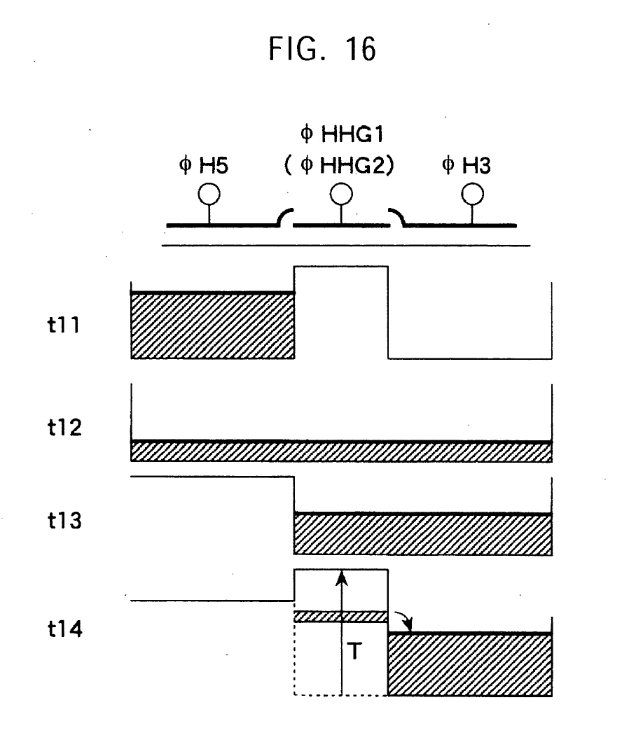

FIG. 15 is a timing chart for explaining an inter-register transfer operation in a second example. FIG. 15 shows timing relationship among the third-phase and fifth-phase clock pulses φH3 and φH5 and the gate pulse φHHG (φHHG1 or φHHG2) during the periods T1 and T6. FIG. 16 is an operation diagram for explaining the inter-register transfer operation in the second example.

In the inter-register transfer operation in this example, as will be understood from the timing chart shown in FIG. 15, during a period between time t13 and time t14, the gate pulse φHHG is gradually shifted from the “H” level to “L′” level, whereby the potential of the inter-register transfer gate 144 or 145 is gradually rendered shallow, so that a period T for transferring signal charges from the inter-register transfer gate 144 to the horizontal transfer register 142 or from the inter-register transfer gate 145 to the horizontal transfer register 143 is maximized.

As described above, when signal charges are transferred from the inter-register transfer gate 144 or 145 to the horizontal transfer register 142 or 143, the potential of the inter-register transfer gate 144 or 145 is gradually rendered shallow. Thus, transfer of signal charges is completed before the potential of the inter-register transfer gate 144 or 145 becomes shallower than the potential of the horizontal transfer registers 141, 142, or 143. Accordingly, signal charges are reliably transferred between registers without causing signal charges to flow reversely from the inter-register transfer gate 144 or 145 to the horizontal transfer register 141 or 142.

Third Example

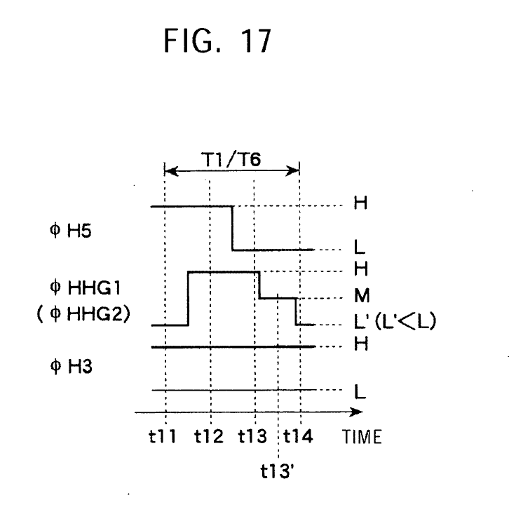

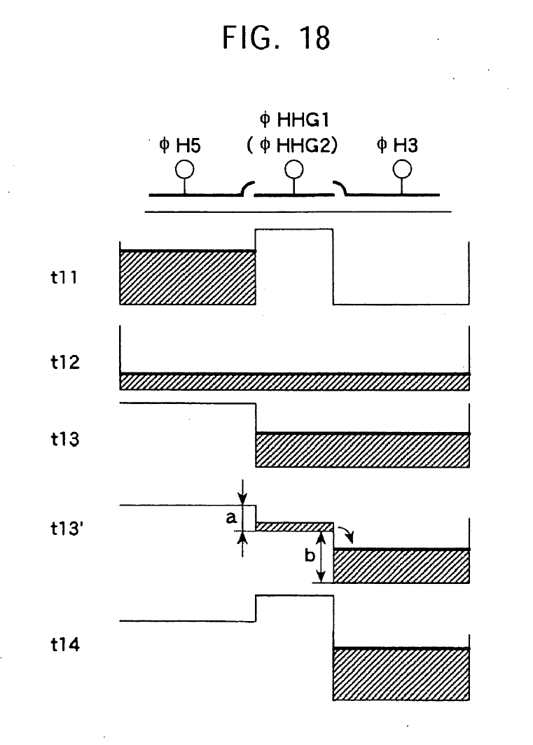

FIG. 17 is a timing chart for explaining an inter-register transfer operation in a third example. FIG. 17 shows timing relationship among the third-phase and fifth-phase clock pulses φH3 and φH5 and the gate pulse φHHG (φHHG1 or φHHG2) during the periods T1 and T6. FIG. 18 is an operation diagram for explaining the inter-register transfer operation in the third example.

In the inter-register transfer operation in this example, during a period between time t13 and time t14, the potential of the inter-register transfer gate 144 or 145 is rendered shallower stepwise, for example, in two steps, so that optimal state for transferring signal charges from the inter-register transfer gate 144 to the horizontal transfer register 142 or from the inter-register transfer gate 145 to the horizontal transfer register 143 will be maintained for a certain period. It is to be understood that the number of steps of changing the potential of the inter-register transfer gate 144 or 145 is not limited to two steps, and the number of steps may be three or more.

More specifically, for example, when the potential of the inter-register transfer gate 144 or 145 is rendered shallower in two steps, as will be understood from the timing chart shown in FIG. 17, the gate pulse φHHG is allowed to take on three values, namely, “H” level, “L′” level (L′<L), and an intermediate “M” level. The gate pulse φHHG is once maintained at “M” level when shifting from “H” level to “L′” level. When this is viewed in comparison with a transfer image, at a time t13′ when the gate pulse φHHG is at “M” level, the potential of the inter-register transfer gate 144 or 145 is maintained at an intermediate potential, so that during the period between the time t13 and t14, the potential of the inter-register transfer gate 144 or 145 is rendered shallower in two steps.

As described above, when signal charges are transferred from the inter-register transfer gate 144 or 145 to the horizontal transfer register 142 or 143, the potential of the inter-register transfer gate 144 or 145 is rendered shallower stepwise, and optimal state for transferring signal charges from the inter-register transfer gate 144 or 145 to the horizontal transfer register 142 or 143 is maintained for a certain period, so that transfer of signal charges is completed during that period. Accordingly, signal charges are reliably transferred without causing signal charges to flow reversely from the inter-register transfer gate 144 or 145 to the horizontal transfer register 141 or 142.

When determining a specific level for “M” level, the following points must be considered. From the viewpoint of electric fields for transfer operations, the difference (b in FIG. 18) between the potential of the inter-register transfer gate 144 or 145 when the gate pulse φHHG is at “M” level and the potential of the horizontal transfer register 142 or 143 when the clock pulses φH1 to φH6 are at “H” level should be maximized. However, as the potential difference increases, the difference (a in FIG. 18) between the potential of the inter-register transfer gate 144 or 145 when the gate pulse φHHG is at “M” level and the potential of the horizontal transfer register 141 or 142 when the clock pulses φH1 to φH6 are at “L” level decreases.

As the latter potential difference decreases, the possibility of signal charges under the inter-register transfer gate 144 or 145 reversely flowing to the horizontal transfer register 141 or 142 increases. The amount of signal charges existing under the inter-register transfer gate 144 or 145 varies depending on the amount of signals handled by the device or time allocated for an inter-register transfer operation. Thus, optimal value for the “M” level of the gate pulse φHHG must be chosen on a device-by-device basis with consideration of the amount of signals handled by the device, time allocated for an inter-register transfer operation, and the like.

Fourth Example

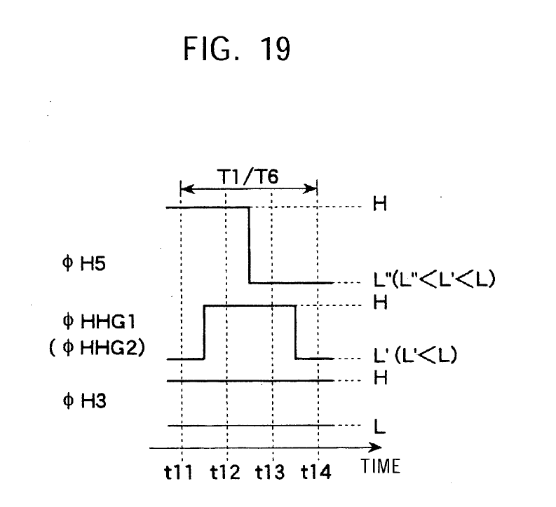

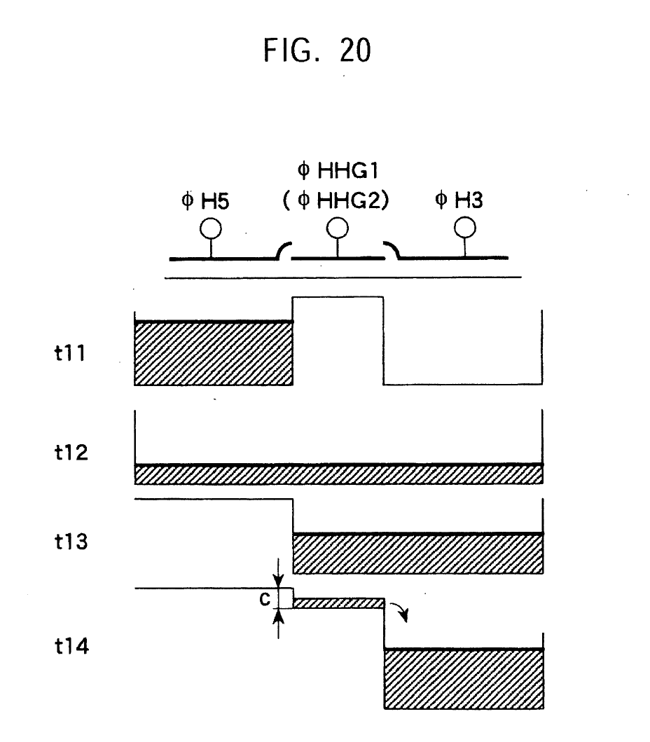

FIG. 19 is a timing chart for explaining an inter-register transfer operation in a fourth example. FIG. 19 shows timing relationship among the third-phase and fifth-phase clock pulses φH3 and φH5 and the gate pulse φHHG (φHHG1 or φHHG2) during the period T1 and T6. FIG. 20 is an operation diagram for explaining the inter-register transfer operation in the fourth example.

In the inter-register transfer operation in this example, the “L” level of the clock pulses φH1 to φH6 for the horizontal transfer registers 141, 142, and 143 is chosen to be lower than the “L′” level of the gate pulses φHHG1 and φHHG2, so that signal charges are inhibited from reversely flowing from the inter-register transfer gates 144 and 145 to the horizontal transfer registers 141 and 142. In this example, the “L” level of the clock pulses φH1 to φH6 for the horizontal transfer registers 141, 142, and 143 will be denoted as “L” level (L″<L′).

As described above, by choosing the “L″” level of the clock pulses φH1 to φH6 of the horizontal transfer registers 141, 142, and 143 to be lower than the “L′” level of the gate pulses φHHG1 and φHHG2, as will be understood from FIG. 20, the shallow potential of the horizontal transfer registers 141 or 142 is shallower than the shallow potential of the inter-register transfer gate 144 or 145, so that signal charges existing under the inter-register transfer gate 144 or 145 are inhibited from flowing reversely to the horizontal transfer registers 141 and 142. Therefore, signal charges are transferred reliably between registers without causing signal charges to flow reversely from the inter-register transfer gate 144 or 145 to the horizontal transfer register 141 or 142.

Also in this example, by the same reason as in the third example, the difference (denoted by c in FIG. 20) between the potentials of the horizontal transfer registers 141 and 142 when the clock pulses φH1 to φH6 are at “L″” level and the potentials of the inter-register transfer gates 144 and 145 when the gate pulses φHHG1 and φHHG2 are at “L′” level should be maximized. However, since the amplitudes of the clock signals φH1 to φH6 increase accordingly, the difference should be maintained at such a value that inverse flow of signal charges will be inhibited.

Furthermore, in this example, the “L″” level of the clock pulses φH1 to φH6 for the horizontal transfer registers 141, 142, and 143 is chosen to be lower than the “L′” level of the gate pulses φHHG1 and φHHG2, so that the shallow potentials of the horizontal transfer registers 141 and 142 are always shallower than the shallow potentials of the inter-register transfer gates 144 and 145. However, inverse flow of signal charges during inter-register transfer operations is inhibited if the shallow potentials of the horizontal transfer registers 141 and 142 are shallower than the shallow potentials of the inter-register transfer gates 144 and 145 at least during the inter-register transfer operations.

The inter-register transfer operations in the second, third, and fourth examples can be used independently or in combination with each other.

Horizontal Transfer Operation for Assigning Signal Charges

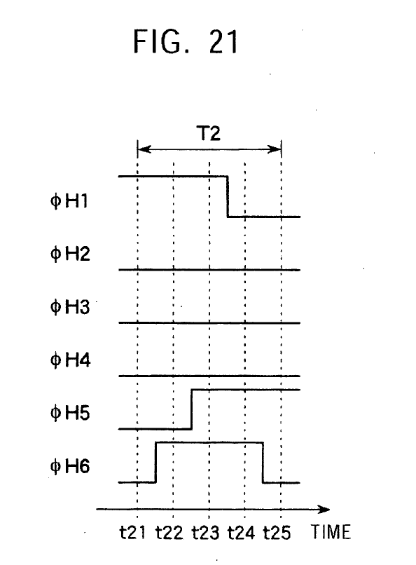

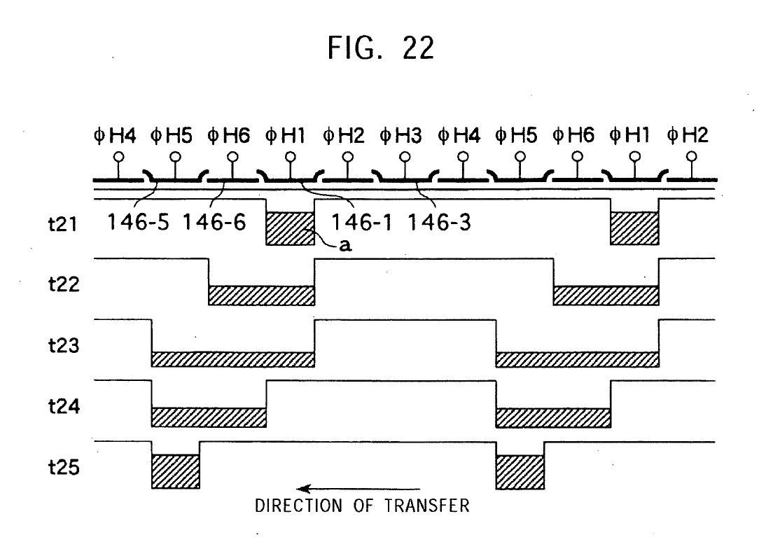

Next, a horizontal transfer operation in the period T2 described earlier will be described in more detail with reference to a timing chart shown in FIG. 21 and a potential diagram shown in FIG. 22. FIG. 21 shows timing relationship of the six-phase clock pulses φH1 to φH6 during the period T2.

During the period T2 shown in FIG. 5, at time t21, the first-phase clock pulse φH1 is at “H” level and the second-phase to sixth-phase clock pulses φH2 to φH6 are at “L” level. In this state, the potential under the transfer electrode 146-1 to which the first-phase clock pulse φH1 is applied is deep, where the signal charge a is accumulated.

During the period T2, the third-phase clock pulse φH3 is supposed to be at “H” level so that the signal charge b is accumulated under the transfer electrode 146-3 to which the clock pulse φH3 is applied. However, in order to clearly describe horizontal transfer of the signal charge a, timing relationship relating to the signal charges b and c will be disregarded.

At time t22, the sixth-phase clock pulse φH6 is at “H” level and the potential under the transfer electrode 146-6 to which the clock pulse φH6 is applied becomes deep, so that the signal charge a accumulated under the transfer electrode 146-1 is spread to the region under the transfer electrode 146-6. At time t23, the fifth-phase clock pulse φH is at “H” level and the potential under the transfer electrode 146-5 to which the clock pulse φH5 is applied becomes deep. Thus, the signal charge a accumulated under the transfer electrodes 146-1 and 146-6 are further spread to the region under the transfer electrode 146-5.

At time t24, the first-phase clock pulse φH1 is back at “L” level and the potential under the transfer electrode 146-1 to which the clock pulse φH1 is applied becomes shallow, so that the signal charge a under the transfer electrode 146-1 is pushed out toward the transfer electrode 146-6. At time t25, the sixth-phase φH6 is also back at “L” level and the potential under the transfer electrode 146-6 to which the clock pulse φH6 is applied becomes shallow. Thus, the signal charge a under the transfer electrode 146-6 is pushed out toward the transfer electrode 146-5.

By the sequence of operations described above, in the horizontal transfer register 141, the signal charge a under the transfer electrode 146-1 is horizontally transferred to the transfer electrode 146-5 that is second next to the left. Horizontal transfer operations during the periods T2, T3, T4, and T5 are basically the same as the horizontal transfer operation during the period T2.

As described above, during horizontal transfer operations for assigning signal charges, when signal charges associated with one pixel are accumulated in a channel under a transfer electrode, first, the potential under a transfer electrode that is adjacent in a transfer-destination direction is rendered deep so that the signal charge will spread in a channel under these two transfer electrodes. Then, the potential under a further adjacent transfer electrode is rendered deep so that the signal charge will be spread in a channel under these three transfer electrodes. Then, the potential under the first transfer electrode and the potential under the adjacent transfer electrode are rendered shallow in order, whereby the signal charges are sequentially pushed from the trailing side. Accordingly, signal charges are horizontally transferred reliably without causing residual charges or reverse flow of signal charges.

Horizontal Transfer Operation after Assigning Signal Charges

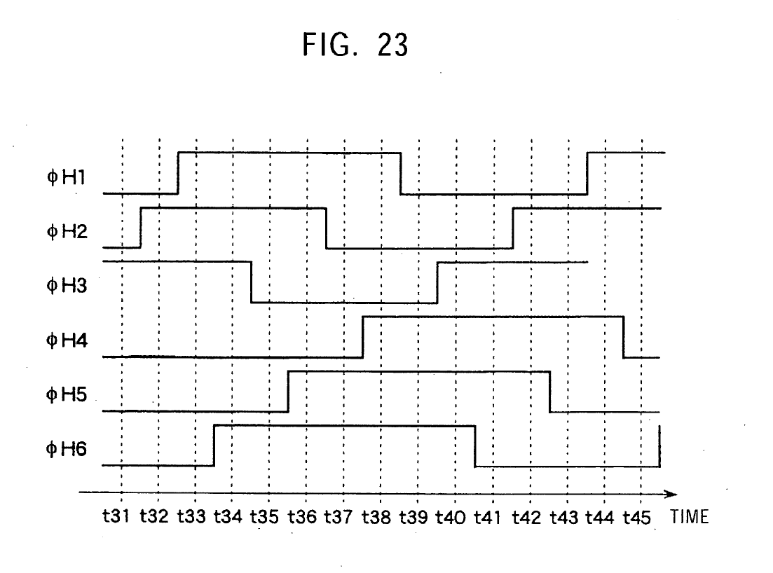

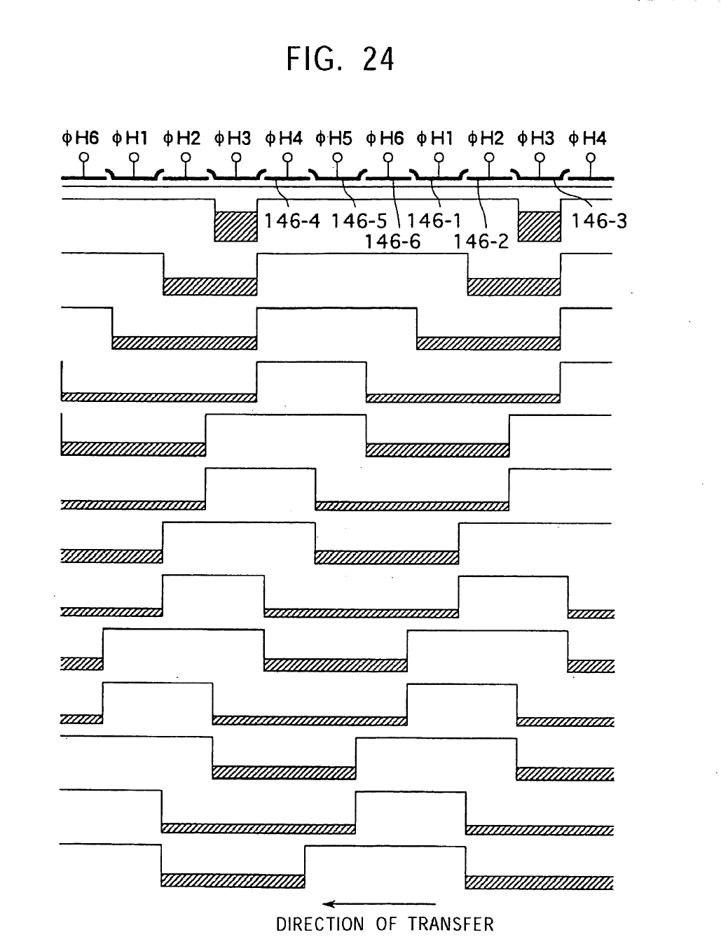

Now, a horizontal transfer operation after the period T6 shown in FIG. 5, i.e., a horizontal transfer operation after assigning signal charges associated with one line to the three horizontal transfer registers 141, 142, and 143, will be described with reference to a timing chart shown in FIG. 23 and a potential diagram shown in FIG. 24. Since horizontal transfer operations are carried out in parallel and in the same manner among the horizontal transfer registers 141, 142, and 143, description will be made in relation to a single horizontal transfer register as an example. FIG. 23 shows timing relationship among the six-phase clock pulses φH1 to φH6.

At time t31, the third-phase clock pulse φH3 is at “H” level, and the other clock pulses φH1, φH2, and φH4 to φH6 are at “L” level. The timing relationship coincides with the timing relationship at the end of the period T6 shown in FIG. 5. In this state, the signal charges a, b, and c are all accumulated under the transfer electrode 146-3 to which the third-phase clock pulse φH3 is applied.

At time t32, the second-phase clock pulse φH2 is at “H” level and the potential under the transfer electrode 146-2 to which the clock pulse φH2 is applied becomes deep, so that the signal charge under the transfer electrode 146-3 is spread to the region under the transfer electrode 146-2. At time t33, the first-phase clock pulse φH1 is at “H” level and the potential under the transfer electrode 146-1 to which the clock pulse φH1 is applied becomes deep, so that the signal charges under the transfer electrodes 146-3 and 146-2 are spread to the region under the transfer electrode 146-1.

At time t34, the sixth-phase clock pulse φH6 is at “H” level and the potential under the transfer electrode 146-6 to which the clock pulse φH6 is applied becomes deep, so that the signal charges under the transfer electrodes 146-3, 146-2, and 146-1 are spread to the region under the transfer electrode 146-6. At time t35, the third-phase clock pulse φH3 is back at “L” level and the potential under the transfer electrode 146-3 to which the clock pulse φH3 is applied becomes shallow, so that the signal charge under the transfer electrode 146-3 is pushed out toward the transfer electrode 146-2.

At time t36, the fifth-phase clock pulse φH5 is at “H” level and the potential under the transfer electrode 146-5 to which the clock pulse φH5 is applied becomes deep, so that the signal charges under the transfer electrodes 146-2, 146-1, and 146-6 are spread to the region under the transfer electrode 146-5. At time t37, the second-phase clock pulse φH2 is back at “L” level and the potential under the transfer electrode 146-2 to which the clock pulse φH2 is applied becomes shallow, so that the signal charge under the transfer electrode 146-2 is pushed out toward the transfer electrode 146-1.

At time t38, the fourth-phase clock pulse φH4 is at “H” level and the potential under the transfer electrode 146-4 to which the clock pulse φH4 is applied becomes deep, so that the signal charges under the transfer electrodes 146-1, 146-6, and 146-5 are spread to the region under the transfer electrode 146-4. At time t39, the first-phase clock pulse φH1 is back at “L” level and the potential under the transfer electrode 146-1 to which the clock pulse φH1 is applied becomes shallow, so that the signal charge under the transfer electrode 146-1 is pushed out toward the transfer electrode 146-6.

At time t40, the third-phase clock pulse φH3 is back at “H” level and the potential under the transfer electrode 146-3 to which the clock pulse φH3 is applied becomes deep, so that the signal charges under the transfer electrodes 146-6, 146-5, and 146-4 are spread to the region under the transfer electrode 146-3. At time t41, the sixth-phase clock pulse φH6 is back at “L” level and the potential under the transfer electrode 146-6 to which the clock pulse φH6 is applied becomes shallow, so that the signal charge under the transfer electrode 146-6 is pushed out toward the transfer electrode 146-5.

At time t42, the second-phase clock pulse φH2 is back at “H” level and the potential under the transfer electrode 146-2 to which the clock pulse φH2 is applied becomes deep, so that the signal charges under the transfer electrodes 146-5, 146-4, and 146-3 are spread to the region under the transfer electrode 146-2. At time t43, the fifth-phase clock pulse φH5 is back at “L” level and the potential under the transfer electrode 146-5 to which the clock pulse φH5 is applied becomes shallow, so that the signal charge under the transfer electrode 146-5 is pushed out toward the transfer electrode 146-4.

At time t44, the first-phase clock pulse φH1 is back at “H” level, and the potential under the transfer electrode 146-1 to which the clock pulse φH1 is applied becomes deep, so that the signal charges under the transfer electrodes 146-4, 146-3, and 146-2 are spread to the region under the transfer electrode 146-1. At time t45, the fourth-phase clock pulse φH4 is back at “L” level, and the potential under the transfer electrode 146-4 to which the clock pulse φH4 is applied becomes shallow, so that the signal charge under the transfer electrode 146-4 is pushed out toward the transfer electrode 146-3.

The state at time t45 coincides with the state at time t33. That is, at time t33, signal charges associated with one pixel are accumulated under the three transfer electrodes 146-3, 146-2, and 146-1. Then, the signal charges associated with three pixels (i.e., associated with six transfer electrodes) are horizontally transferred, reaching the state at time t45. Then, by iterations of the periods from time t34 to time t44, the signal charges a, b, and c are horizontally transferred in parallel by the three horizontal transfer registers 141, 142, and 143.

As described above, in a horizontal transfer operation after assigning signal charges associated with one line to the three horizontal transfer registers 141, 142, and 143, a transfer operation is carried out while constantly maintaining signal charges associated with one pixel to be accumulated under at least three transfer electrodes. Accordingly, time for transferring signal charges between channels under individual transfer electrodes is increased, so that signal charges are horizontally transferred reliably without causing residual signal charges or reverse flow of signal charges. It is to be understood that the sequence of procedure in the horizontal transfer operation described above is only an example, and the present invention is not limited to the example.

Second Embodiment

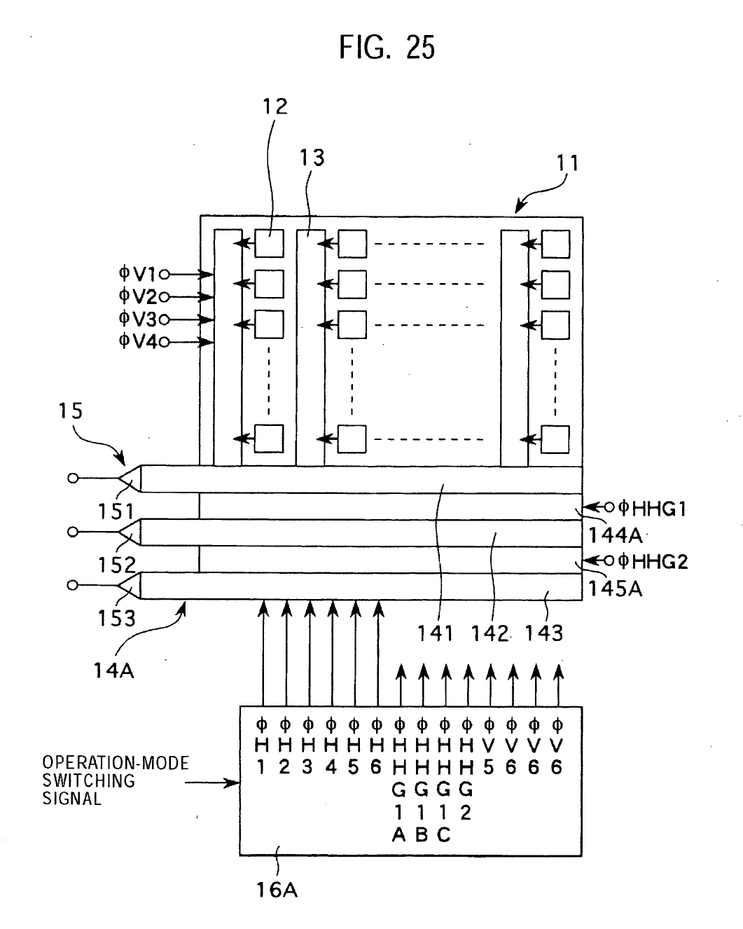

FIG. 25 is a schematic diagram showing the construction of a solid-state imaging device, such as a CCD imaging device, according to a second embodiment of the present invention. In FIG. 25, parts corresponding to those in FIG. 3 are designated by the same numerals.

The CCD imaging device according to the second embodiment is constructed basically the same as the CCD imaging device according to the first embodiment described above. However, the CCD imaging device according to the second embodiment differs in that it includes a horizontal transfer unit 14A instead of the horizontal transfer unit 14 in the first embodiment. The horizontal transfer unit 14A includes, for example, three horizontal transfer registers 141, 142, and 143, and inter-register transfer gates 144A and 145A. The horizontal transfer registers 141, 142, and 143 horizontally transfer in parallel signal charges shifted line by line from the respective vertical transfer registers. The inter-register transfer gates 144A are provided between the horizontal transfer registers 141 and 142, and transfer signal charges from the horizontal transfer register 141 closer to the imaging unit 11 to the horizontal transfer register 142 remoter from the imaging unit 11. The inter-register transfer gates 145A are provided between the horizontal transfer registers 142 and 143, and transfer signal charges from the horizontal transfer register 142 closer to the imaging-unit 11 to the horizontal transfer register 143 remoter from the imaging unit 11.

The CCD imaging device according to the second embodiment is allowed to operate in a first operation mode and a second operation mode, and either the first operation mode or the second operation mode is selected as appropriate. In the first operation mode, signal charges are assigned to all the three horizontal transfer registers 141, 142, and 143 to carry out horizontal transfer operations. On the other hand, in the second operation mode, signal charges are assigned to only part of the three horizontal transfer registers, for example, the two horizontal transfer registers 141 and 142, to carry out horizontal transfer operations. Switching between the first and second operation modes is controlled according to an operation-mode switching signal that is externally supplied.

In the CCD imaging device according to the second embodiment, the switching of operation mode of the horizontal transfer unit 14A, i.e., switching between the first and second operation modes, is allowed by the inter-register transfer gates 144A. That is, the CCD imaging device according to the second embodiment differs from the CCD imaging device according to the first embodiment with respect to the specific construction of the inter-register transfer gates 144A and the operation thereof. Furthermore, in order to allow mode switching by the inter-register transfer gates 144A, a timing generator 16A generates three kinds of gate pulses φHHG1A, φHHG1B, and φHHHG1C as gate pulses φHHHG1 for driving the inter-register transfer gates 144A, at timing in accordance with the first or second operation mode, and supplies the gate pulses φHHG1A, φHHG1B, and φHHG1C to the inter-register transfer gates 144A.

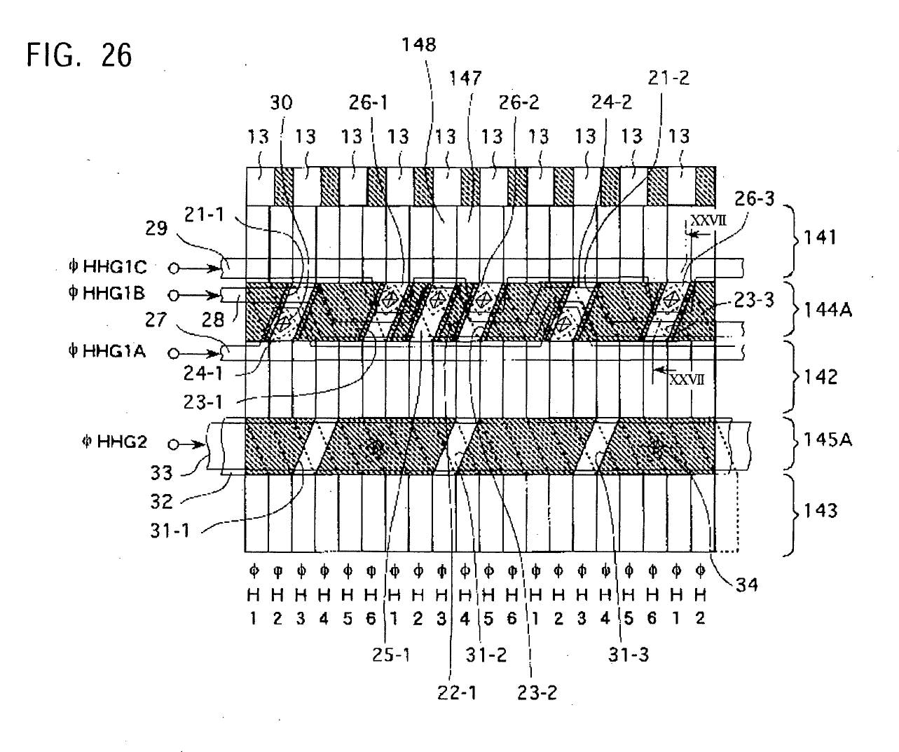

FIG. 26 is a schematic diagram showing a planar pattern of a specific structure of the horizontal transfer unit 14A in the CCD imaging device according to the second embodiment. In FIG. 26, parts corresponding to those in FIG. 4 are designated by the same numerals. In FIG. 26, hatched regions represent channel stop regions, and regions surrounded by broken lines represent transfer electrodes to which clock pulses of a common phase are applied.

Each of the horizontal transfer registers 141, 142, and 143 is implemented by a CCD including a series of a large number of transfer stages that serve as units for sequentially transferring signal charges. Each of the transfer stages includes m (m is an integer not smaller than two) transfer electrodes, for example, two transfer electrodes 146 and 147. That is, a transfer stage is formed by the two transfer electrodes 146 and 147 and a channel region under the transfer electrodes 146 and 147. Six transfer electrodes associated with three adjacent transfer stages are considered as a unit, and clock pulses φH1 to φH6 of six (=2×3) phases are supplied independently to the respective six transfer electrodes.

The inter-register transfer gates 144A have a first line of transfer channels 21-1, 21-2, . . . , a second line of transfer channels 22-1, 22-2, . . . , and a third line of transfer channels 23-1, 23-2, 23-3, . . . . The first line of transfer channels 21-1, 21-2, . . . are provided between the horizontal transfer register 141 and the horizontal transfer register 142 at an interval of five transfer stages, i.e., one for each set of six transfer stages (i.e., twelve transfer electrodes). The second line of transfer channels are provided in intermediate regions with respect to the adjacent pairs of the first line of transfer channels 21-1, 21-2, . . . , more specifically, in regions shifted by two transfer stages with respect to the first line of transfer channels 21-1, 21-2, . . . , one being provided for each set of six transfer stages. The third line of transfer channels 23-1, 23-2, 23-3, . . . are provided in transfer stages on both sides adjacent to the second line of transfer channels 22-1, 22-2, . . . .

The inter-register transfer gates 144A also have a first line of gate electrodes 24-1, 24-2, . . . provided over the first line of transfer channels 21-1, 21-2, . . . , a second line of gate electrodes 25-1, 25-2, . . . provided over the second line of transfer channels 22-1, 22-2, . . . , a third line of gate electrodes 26-1, 26-2, 26-3, . . . provided over the third line of transfer channels 23-1, 23-2, 23-3, . . . , a first line of wire 27 for transmitting the gate pulse (driving bias)φHHG1A to the first line of gate electrodes 24-1, 24-2, a second line of wire 28 for transmitting the gate pulse φHHG1B to the second line of gate electrodes 25-1, 25-2, and a third line of wire 29 for transmitting the gate pulse φHHG1C to the third line of gate electrodes 26-1, 26-2, 26-3, . . . .

The first line of gate electrodes 24-1, 24-2, . . . , the second line of gate electrodes 25-1, 25-2, . . . , and the third line of gate electrodes 26-1, 26-2, 26-3, . . . are composed of polysilicon and formed in island shapes respectively for the associated transfer channels. The first, second, and third lines of wires 27, 28, and 29 are composed of a metal such as aluminum or tungsten. The first, second, and third lines of wires 27, 28, and 29 are arranged along a direction of transferring charges by the horizontal transfer registers 141 and 142, and are electrically connected to the associated lines of gate electrodes 24 (24-1, 24-2, . . . ), 25 (25-1, 25-2, . . . ), and 26 (26-1, 26-2, 26-3, . . . ) via contact portions 30, respectively. The lines 27, 28, and 29 also function as shunts for the gate electrodes 24, 25, and 26.

The inter-register transfer gates 145A have transfer channels 31-1, 31-2, 31-3, . . . , one being provided for each set of three transfer stages of two transfer electrodes 146 and 147 (i.e., for each set of six transfer electrodes), a gate electrode 32 commonly connected to the transfer channels 31-1, 31-2, 31-3, . . . , and a wire 33 for transmitting a gate pulse φHHG2 to the gate electrode 32. The wire 33 is electrically connected to the gate electrode 32 via a contact portion 34. When the gate pulse φHHG2 is applied to the gate electrode 32, signal charges in the horizontal transfer register 142 are selectively transferred to the horizontal transfer register 143 through the transfer channels 31-1, 31-2, 31-3, . . . under the gate electrode 32.

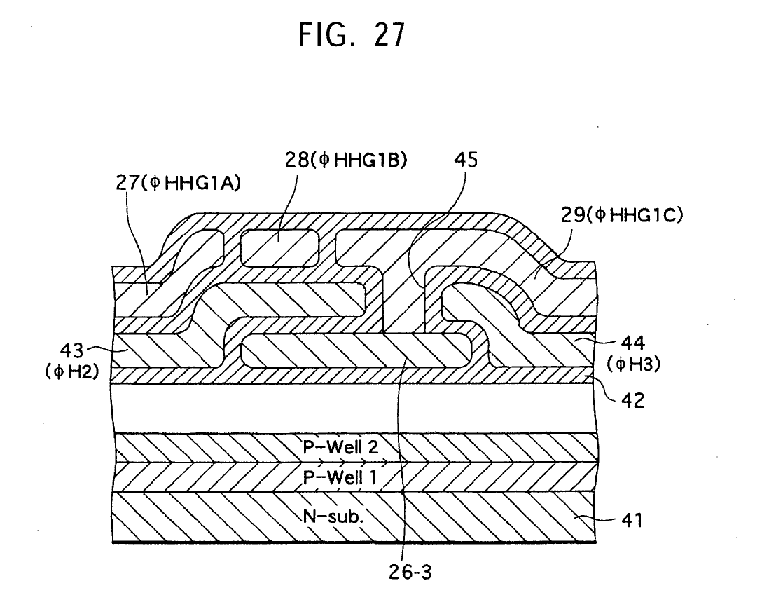

FIG. 27 is a sectional view taken along a line XXVII-XXVII in FIG. 26, showing an example sectional structure of the electrode 26-3. Referring to FIG. 27, the electrode 26-3 composed of polysilicon and is formed in an island shape in a first layer disposed via an insulating film 42 on a surface of an N-type silicon substrate 41. The surface layer of the substrate 41 under the gate electrode 26-3 functions as the transfer channel 23-3 of the third line. Over the gate electrode 26-3, a transfer electrode 43 of the horizontal transfer register 142 associated with the clock pulse φH2 is provided by a second layer of polysilicon. Furthermore, a transfer electrode 44 of the horizontal transfer register 141 associated with the clock pulse φH3 is provided by a third layer of polysilicon. On an uppermost layer, the shunt wires 27, 28, and 29 are formed of aluminum, tungsten, or the like.

In order to connect the shunt wire 29 to the gate electrode 26-3, a hole 45 is provided between the second and third polysilicon layer correspondingly to the contact portion so that the gate electrode 26-3 formed by the first layer of polysilicon will not be covered by the transfer electrode 43 formed by the second polysilicon layer and the transfer electrode 44 formed by the third polysilicon layer. The shunt wire 29 is electrically connected to the gate electrode 26-3 through the hole 45. Although the description has been made in the context of the sectional structure of the gate electrode 26-3, the sectional structures of the other gate electrodes are substantially the same.

Now, operations in a three-channel-output operation mode and a two-channel output operation mode of the three-channel-output CCD imaging device according to this embodiment will be described.

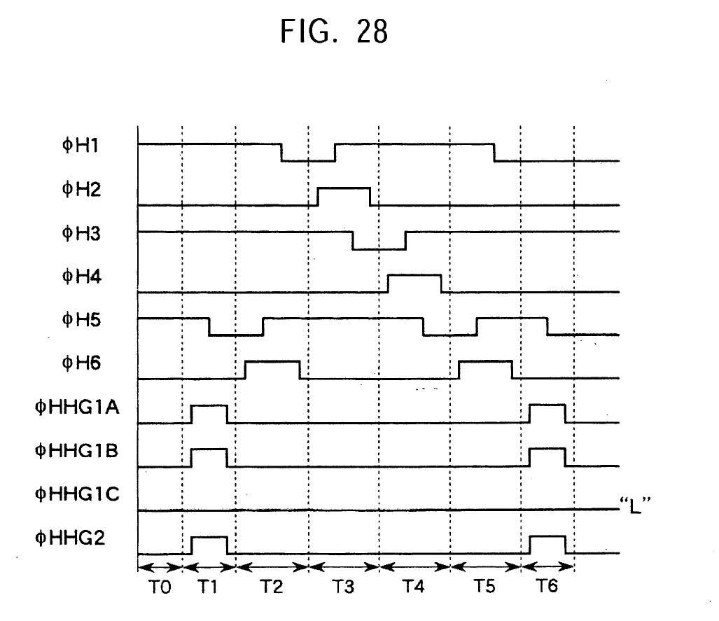

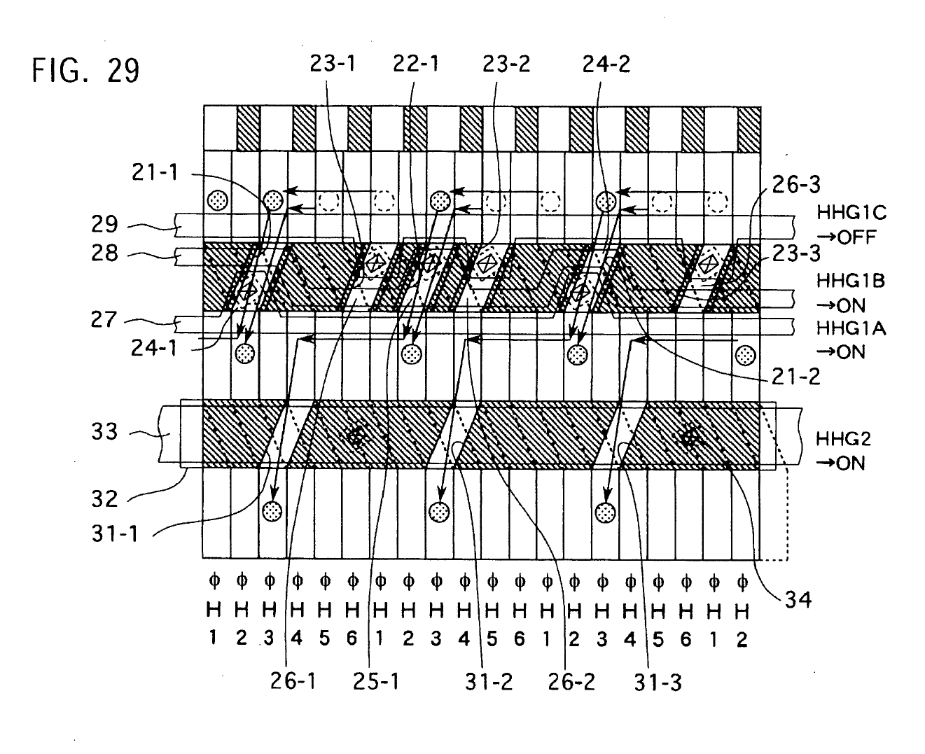

First, an operation in the three-channel-output operation mode will be described based on a timing chart shown in FIG. 28 with reference to an operation diagram shown in FIG. 29. In the case of the three-channel-output operation mode, with regard to signal charges associated with one line, signal charges associated with adjacent three pixels are considered as a unit, and the signal charges associated with the three pixels are assigned to three horizontal transfer registers 141, 142, and 143 and are horizontally transferred by the three horizontal transfer registers 141, 142, and 143.

During a period T0, the odd-numbered-phase clock pulses φH1, φH3, and φH5 are at “H” level, and the even-numbered-phase clock pulses φH2, φH4, and φH6 are at “L” level. In this state, first, signal charges associated with one line are transferred from the respective vertical transfer registers 13 to the horizontal transfer register 141.

During a period T1, when the gate pulses φHHG1A and φHHG1B are both pulled to “H” level and the gate pulse φHHG1C is pulled to “L” level, the potentials of the transfer channels 21-1, 21-2, . . . under the first line of electrodes 24-1, 24-2, . . . and the potentials of the transfer channels 22-1, 22-2, . . . under the second line of transfer electrodes 25-1, 25-2, . . . become deep. On the other hand, the potentials of the transfer channels 23-1, 23-2, 23-3, under the third line of electrodes 26-1, 26-2, 26-3, become shallow.

Thus, the first line of transfer channels 21-1, 21-2, and the second line of transfer channels 22-1, 22-2, . . . are enabled to act as transfer gates for transferring signal charges from the horizontal transfer register 141 to the horizontal transfer register 142. On the other hand, the third line of transfer channels 23-1, 23-2, 23-3, . . . are enabled to act as block gates that block transfer of signal charges from the horizontal transfer register 141 to the horizontal transfer register 142. This state corresponds to the state in the period T1 in the timing chart shown in FIG. 5 for explaining the operation of the CCD imaging device according to the first embodiment. During the period T1, the first inter-register transfer operation is carried out.

Thereafter, the operation proceeds similarly to the case of the CCD imaging device according to the first embodiment. Then, in a period T6, the gate pulses φHHG1A and φHHG1B are both pulled to “H” level, the gate pulse φHHG1C is pulled to “L” level, and the gate pulse φHHG2 is pulled to “H” level. Thus, similarly to the case of the CCD imaging device according to the first embodiment, the second inter-register transfer operation is carried out, in which signal charges in the horizontal transfer register 141 are transferred to the horizontal transfer register 142 through the first line of transfer channels 21-1, 21-2, . . . and the second line of transfer channels 22-1, 22-2, . . . , and in which signal charges in the horizontal transfer register 142 are transferred to the horizontal transfer register 143 through the transfer channels 31-1, 31-2, 31-3, . . . .

As described above, in the three-channel-output operation mode, signal charges sequentially supplied line by line from the imaging unit 11 are assigned to the three horizontal transfer registers 141, 142, and 143 by inter-register transfer operations of the inter-register transfer gates 144A and 145A. After the signal charges are assigned to the horizontal transfer registers 141, 142, and 143, the signal charges are horizontally transferred in parallel by the horizontal transfer registers 141, 142, and 143, and finally output signals of three channels are derived.

In the three-channel-output operation mode, similarly to the case of the CCD imaging device according to the first embodiment, the transfer electrodes 146 and 147 are driven independently by the six-phase clock pulses φH1 to φH6, allowing control of channel potential individually for each of the transfer electrodes. Therefore, potential is not reversed between sending and receiving channels, and horizontal transfer does not occur while signal charges are being assigned. Accordingly, even in the case of a multiple-channel-output CCD imaging device having three or more horizontal transfer registers, inter-register transfer operations are carried out reliably. Therefore, even when the number of pixels is increased, the frame rate can be increased by increasing the number of horizontal transfer registers, and the increased frame rate allows decrease in the driving frequency of horizontal transfer operations. Accordingly, power consumption of the CCD imaging device is reduced.

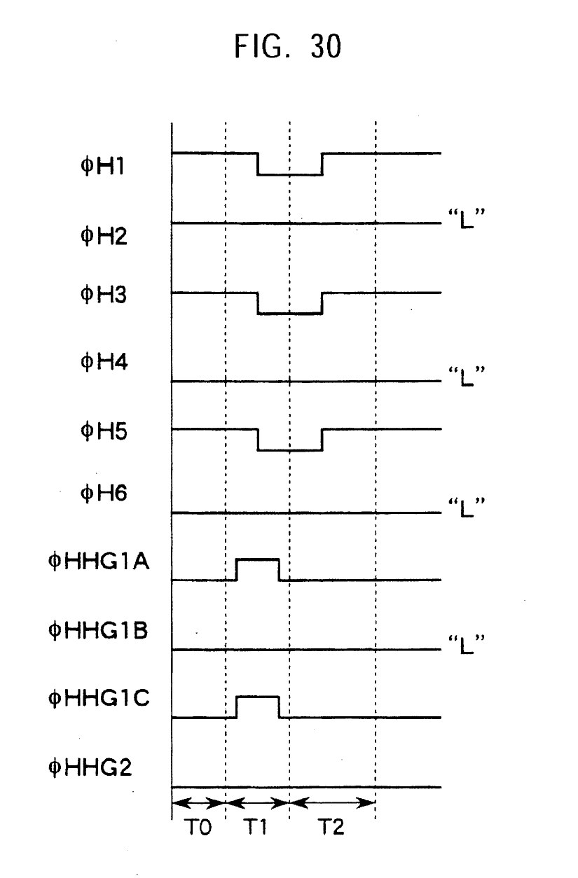

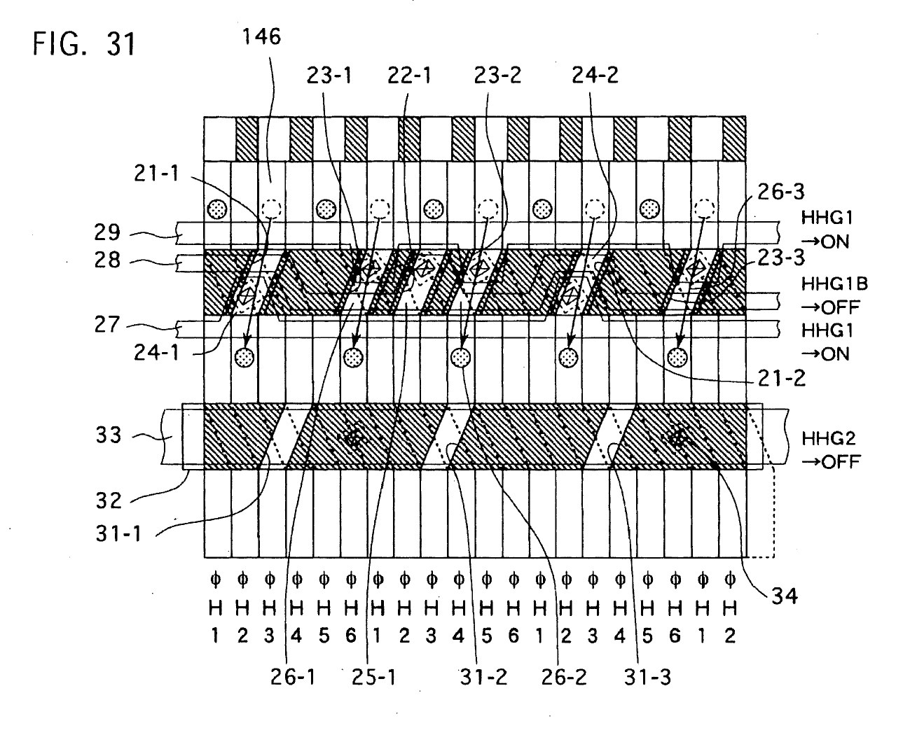

Next, an operation in the two-channel-output operation mode will be described based on a timing chart shown in FIG. 30 and with reference to an operation diagram shown in FIG. 31. In the two-channel-output operation mode, with regard to signal charges associated with one line, signal charges associated with two adjacent pixels are considered as a unit, and the signal charges associated with the two pixels are assigned to the two horizontal transfer registers 141 and 142 and are horizontally transferred by the horizontal transfer registers 141 and 142.

During a period T0, the odd-numbered-phase clock pulses φH1, φH3, and φH5 are at “H” level, and the even-numbered-phase clock pulses φH2, φH4, φH6 are at “L” level. In this state, first, signal charges associated with one line are horizontally transferred from the respective vertical transfer registers 13 to the horizontal transfer register 141.

During a period T1, when the gate pulses φHHG1A and HHG1C are both pulled to “H” level and the gate pulse φHHG1B is pulled to “L” level, the potentials of the transfer channels 21-1, 21-2, . . . under the first line of electrodes 24-1, 24-2, . . . and the potentials of the transfer channels 23-1, 23-2, 23-3, . . . under the third line of electrodes 26-1, 26-2, 26-3, . . . become deep. On the other hand, the potentials of the transfer channels 22-1, 22-2, . . . under the second line of electrodes 25-1, 25-2, . . . become shallow.

Thus, the first line of transfer channels 21-1, 21-2, and the third line of transfer channels 23-1, 23-2, 23-3, are enabled to act as transfer gates for transferring signal charges from the horizontal transfer register 141 to the horizontal transfer register 142. On the other hand, the second line of transfer channels 22-1, 22-2, . . . are enabled to act as block gates that block transfer of signal charges from the horizontal transfer register 141 to the horizontal transfer register 142.

In this state, the first-phase, third-phase, and fifth-phase clock pulses φH1, φH3, and φH5 are pulled to “L” level, whereby signal charges of the channels under the transfer electrodes 146 in the horizontal transfer register 141 are moved to the first line of transfer channels 21-1, 21-2, . . . and the third line of transfer channels 23-1, 23-2, 23-3, . . . . At this time, the second-phase, fourth-phase, and sixth-phase clock pulses φH2, φH4, and φH6 are at “L” level.

Thereafter, the first-phase, third-phase, and fifth-phase clock pulses φH1, φH3, and φH5 are pulled to “H” level, whereby signal charges in the first line of transfer channels 21-1, 21-2, . . . and the third line of transfer channels 23-1, 23-2, 23-3, . . . are moved to the channels under the transfer electrodes 146 in the horizontal transfer register 14.2. This completes the assigning of signal charges to the two horizontal transfer registers 141 and 142.

As described above, in the two-channel-output operation mode, signal charges sequentially supplied line by line from the imaging unit 11 are assigned to the two horizontal transfer registers 141 and 142 by inter-register transfer operations of the inter-register transfer gates 144A. After the signal charges are assigned to the horizontal transfer registers 141 and 142, the signal charges are horizontally transferred in parallel by the horizontal transfer registers 141 and 142, and finally output signals of two channels are derived. The driving frequency of horizontal transfer operations in the two-channel-output operation mode, i.e., the frequency of the six-phase clock pulses φH1 to φH6, is chosen to be 1.5 (=3/2) times the driving frequency of horizontal transfer operations in the three-output-channel operation mode.

As described above, in a multiple-channel-output CCD imaging device having n (three in this embodiment) horizontal transfer registers, over the transfer channels of a set of inter-register transfer channels, in this embodiment, over the transfer channels of the inter-register transfer gates 144A, the three lines of gate electrodes 21 (21-1, 21-2, . . . ), 22 (22-1, 22-2, . . . ), and 23 (23-1, 23-2, . . . ) are provided, and driving biases (i.e., the gate pulses φHHG1A, φHHG1B, and φHHG1C) are provided as appropriate to the respective gate electrodes. More specifically, driving biases are provided to gate electrodes associated with transfer registers used according to an operation mode, so that the transfer channels associated with the gate electrodes act as transfer gates for transferring signal charges between the horizontal transfer registers 141 and 142 while the other channels act as blocking gates that block transfer of signal charges between the horizontal transfer registers 141 and 142.

Thus, it is possible to select either the three-channel-output operation mode in which signal charges are assigned to all the three horizontal transfer registers 141, 142, and 143 and are transferred by the three horizontal transfer registers 141, 142, and 143, or the two-channel-output operation mode in which signal charges are assigned only to the two horizontal transfer registers 141 and 142 among the three horizontal transfer registers 141, 142, and 143, and are transferred by the two horizontal transfer registers 141 and 142. Without limitation to the two-channel-output operation mode, the latter mode may use an arbitrary number of horizontal transfer registers. That is, in a multiple-channel-output CCD imaging device having a plurality of horizontal transfer registers to achieve a higher frame rate, in addition to an operation mode in which all the horizontal transfer registers are constantly used for horizontal transfer operations, it is possible to select an operation mode in which an arbitrary number of horizontal transfer registers is used for horizontal transfer operations.

When the second operation mode in which an M (an arbitrary number) horizontal transfer registers among N horizontal transfer register is used is selected, in order that the frame rate be the same as in the case of the first operation mode in which all the N horizontal transfer registers are used, the driving frequency of horizontal transfer registers should be chosen to be N/M times the driving frequency in the first operation mode. That is, the driving frequency in the second operation mode is N/M times as high as the driving frequency in the first operation mode. As described above, the driving frequency is increased in the second operation mode by switching of operation mode. Thus, although power consumption is increased, the following advantages are achieved.

Since the driving frequency of the horizontal driving unit 14A is increased, in a signal processing system at a subsequent stage, that multiplexes signals of a plurality of channels to generate a video signal, the video signal need not be passed through a low-pass filter for removing a component of the driving frequency from the video signal. Therefore, decrease in the degree of amplitude modulation in the vicinity of limiting resolution due to the low-pass filter is prevented. Thus, the bandwidth of the video signal is not reduced, so that resolution is improved compared with the case of the first operation mode in which the degree of amplitude modulation in the vicinity of limiting resolution is decreased by the low-pass filter.

Although the embodiments have been described in the context of a multiple-channel-output CCD imaging device that horizontally transfers signal charges in parallel by the three horizontal transfer registers 141, 142, and 143, without limitation to the embodiments, the present invention may be similarly applied to a multiple-channel-output CCD imaging device having two output channels or four or more output channels.

It is to be noted that a three-channel-output CCD imaging device, when it is capable of representing colors, is allowed to handle three adjacent signal charges a, b, and c as signal charges associated with red (R), green (G), and blue (B). This is very advantageous for signal processing. From this viewpoint, the number of output channels is preferably an integer multiple of three, such as six output channels. In the case of a six-channel-output CCD imaging device, clock pulses of 12 (=2×6) phases are used to independently drive transfer electrodes, two transfer electrodes being provided for each transfer stage.

Although two transfer electrodes are provided for each transfer stage in the embodiments described above, three or more transfer electrodes may be provided for each transfer stage. When the number of transfer electrodes is increased, a transferring distance (transferring length) of each transfer electrode is shortened. This is advantageous in terms of transfer efficiency.

Furthermore, although the embodiments have been described by way of examples where the present invention is applied to horizontal transfer units of area sensors where pixels including photoelectric conversion elements are arranged in matrix shapes, without limitation to the application to area sensors, the present invention may be similarly applied to horizontal transfer units of linear sensors (line sensors) in which pixels including photoelectric converters are arranged linearly.

1. A solid-state imaging device comprising:
a pixel area where pixels including photoelectric conversion elements are disposed; and
a charge transferring unit that transfers n channels of signal charges in parallel, the signal charges being obtained by photoelectric conversion by the pixels in the pixel area, where n is an integer not smaller than two;
wherein the charge transferring unit comprises:
n transfer registers having transfer stages that sequentially transfer signal charges, each of the transfer stages having m transfer electrodes, where m is an integer not smaller than two, the respective transfer electrodes being driven independently by clock pulses of m×n phases; and
inter-register transfer gates provided between the n transfer registers at an interval of at least one of the transfer electrodes.

2. The solid-state imaging device according to claim 1, wherein the inter-register transfer gates have channels for transferring signal charges, the channels having entrances and exits, the entrances being provided under transfer electrodes to which clock pulses having a phase that is common between transfer registers that send signal charges are applied, and the exits being provided under transfer electrodes to which clock pulses having a phase that is common between transfer registers that receive signal charges and that is different from the phase of the clock pulses associated with the transfer registers that send signal charges are applied.

3. The solid-state imaging device according to claim 1, further comprising controlling means, wherein of the n transfer registers, when signal charges obtained by photoelectric conversion by the pixels of the pixel area have been transferred to a transfer register of a first stage, the controlling means, handling adjacent n signal charges as a unit, exercises control to leave a leading signal charge in a direction of transfer in the transfer register of the first stage, and to transfer the following (n−1) signal charges sequentially to the entrances of the inter-register transfer gates to carry out an inter-register transfer operation, finally arranging the signal charges under transfer electrodes of the n transfer registers to which clock pulses of a common phase are applied.

4. The solid-state imaging device according to claim 3, wherein in the inter-register transfer operation, when signal charges associated with one pixel have been accumulated in channels under transfer electrodes that send signal charges, the controlling means first renders potentials of the inter-register transfer gates deeper to increase accumulation of signal charges to a deeper potential and renders potentials under transfer electrodes that receive signal charges deeper to increase accumulation of signal charges to a deeper potential, and then renders shallower the potentials under the transfer electrodes that send signal charges and the potentials of the inter-register transfer gates in that order.

5. The solid-state imaging device according to claim 4, wherein when rendering shallower the potentials of the inter-register transfer gates in the inter-register transfer operation, the control means renders the potentials shallower gradually.

6. The solid-state imaging device according to claim 4, wherein when rendering shallower the potentials of the inter-register transfer gates in the inter-register transfer operation, the control means renders the potentials shallower stepwise.

7. The solid-state imaging device according to claim 4, wherein at least in the inter-register transfer operation, the potentials having been rendered shallower of the transfer registers that send signal charges are even shallower than the potentials having been rendered shallower of the inter-register transfer gates.

8. A solid-state imaging device comprising:
a pixel area that carries out photoelectric conversion; and
a charge transferring unit that transfers signal charges obtained by the pixel area;
wherein the charge transferring unit comprises:
n transfer registers having transfer stages that sequentially transfer the signal charges, where n is an integer not smaller than two, each of the transfer stages having m transfer electrodes, where m is an integer not smaller than two, the transfer electrodes being driven by clock pulses of m×n phases;
a set of inter-register transfer channels that transfers signal charges between the n transfer registers, the inter-register transfer gates being provided between the n transfer registers at an interval of at least one of the transfer electrodes;
a set of gate electrodes provided over the set of inter-register transfer channels; and
driving means for applying biases to a number of gate electrodes among the set of gate electrodes in accordance with a number of transfer registers that is used among the n transfer registers.

9. The solid-state imaging device according to claim 8, wherein the respective gate electrodes of the set of gate electrodes are provided in island shapes for the respective transfer channels among the set of inter-register transfer channels.

10. The solid-state imaging device according to claim 8, wherein electrode wires for transmitting the biases to the respective gate electrodes among the set of gate electrodes are provided along a direction of transferring signal charges by the transfer registers.

11. The solid-state imaging device according to claim 10, wherein the electrode wires are provided individually for each unit of gate electrodes associated with each of the transfer registers that are used among the set of gate electrodes.

12. A method of driving a solid-state imaging device, the solid-stage imaging device including:
a pixel area where pixels including photoelectric conversion elements are disposed; and
a charge transferring unit that transfers n channels of signal charges in parallel, the signal charges being obtained by photoelectric conversion by the pixels in the pixel area, where n is an integer not smaller than two;
the charge transferring unit including:
n transfer registers having transfer stages that sequentially transfer signal charges, each of the transfer stages having m transfer electrodes, where m is an integer not smaller than two; and
inter-register transfer gates provided between the n transfer registers at an interval of at least one of the transfer electrodes;
wherein the respective transfer electrodes of the n transfer registers are driven independently by clock pulses of m×n phases.

13. The method of driving a solid-state imaging device according to claim 12, wherein of the n transfer registers, when signal charges obtained by photoelectric conversion by the pixels of the pixel area have been transferred to a transfer register of a first stage, handling adjacent n signal charges as a unit, a leading signal charge in a direction of transfer is left in the transfer register of the first stage, and the following (n−1) signal charges are transferred sequentially to entrances of the inter-register transfer gates to carry out an inter-register transfer operation, finally arranging the signal charges under transfer electrodes of the n transfer registers to which clock pulses of a common phase are applied.

14. The method of driving a solid-state imaging device according to claim 13, wherein in the inter-register transfer operation, when signal charges associated with one pixel have been accumulated in channels under transfer electrodes that send signal charges, first, potentials of the inter-register transfer gates are rendered deeper to increase accumulation of signal charges to a deeper potential and potentials under transfer electrodes that receive signal charges are rendered deeper to increase accumulation of signal charges to a deeper potential, and then the potentials under the transfer electrodes that send signal charges and the potentials of the inter-register transfer gates are rendered shallower in that order.

15. The method of driving a solid-state imaging device according to claim 14, wherein when rendering shallower the potentials of the inter-register transfer gates in the inter-register transfer operation, the potentials are rendered shallower gradually.

16. The method of driving a solid-state imaging device according to claim 14, wherein when rendering shallower the potentials of the inter-register transfer gates in the inter-register transfer operation, the potentials are rendered shallower stepwise.

17. The method of driving a solid-state imaging device according to claim 14, wherein at least in the inter-register transfer operation, the potentials having been rendered shallower of the transfer registers that send signal charges are even shallower than the potentials having been rendered shallower of the inter-register transfer gates.

18. A method of driving a solid-state imaging device, the solid-state imaging device including:
a pixel area that carries out photoelectric conversion; and
a charge transferring unit that transfers signal charges obtained by the pixel area;
the charge transferring unit including:
n transfer registers having transfer stages that sequentially transfer the signal charges, where n is an integer not smaller than two, each of the transfer stages having m transfer electrodes, where m is an integer not smaller than two, the transfer electrodes being driven by clock pulses of m×n phases;
a set of inter-register transfer channels that transfers signal charges-between the n transfer registers, the inter-register transfer gates being provided between the n transfer registers at an interval of at least one of the transfer electrodes; and
a set of gate electrodes provided over the set of inter-register transfer channels;
wherein biases are applied to a number of gate electrodes among the set of gate electrodes in accordance with a number of transfer registers that is used among the n transfer registers.
